(19) United States
(12) Patent Application Publication
(10) Pub. No.: US 2023/0189220 A1
(43) Pub. Date: Jun. 15, 2023

(54) TRANSMISSION CONTROL METHOD AND APPARATUS, AND ELECTRONIC DEVICE

(71) Applicant: VIVO MOBILE COMMUNICATION CO., LTD., Dongguan (CN)

(72) Inventors: Siqi LIU, Dongguan (CN); Zichao JI, Dongguan (CN); Shixiao LIU, Dongguan (CN); Yu ZENG, Dongguan (CN)

(73) Assignee: VIVO MOBILE COMMUNICATION CO., LTD., Dongguan (CN)

(21) Appl. No.: 18/105,839

(22) Filed: Feb. 4, 2023

Related U.S. Application Data
(63) Continuation of application No. PCT/CN2021/110896, filed on Aug. 5, 2021.

(30) Foreign Application Priority Data
Aug. 5, 2020 (CN) 202010779365.4

(51) Int. Cl. H04W 72/04; H04W 76/28

(52) U.S. Cl. CPC H04W 72/04; H04W 76/28

(57) ABSTRACT

A transmission control method and apparatus, and an electronic device are provided, The transmission control method includes: performing, by a first terminal, any one of the following operations after transmitting a target object: transmitting an associated resource of the target object; scheduling or configuring the associated resource of the target object to be within an active time or beyond an inactive time of a first configuration; and performing a first operation so that the associated resource of the target object is within the active time or beyond the inactive time of the first configuration.

### CROSS-REFERENCE TO RELATED APPLICATIONS

This application is a continuation of International Application No PCT/CN2021/110896, filed on Aug. 5, 2021, which claims priority to Chinese Patent Application No. 202010779365.4, filed on Aug. 5, 2020. The entire contents of each of the above-identified applications are expressly incorporated herein by reference.

### TECHNICAL FIELD

This application relates to the field of communications technologies, and in particular, to a transmission control method and apparatus, and an electronic device.

### BACKGROUND

A discontinuous reception mechanism is introduced in a new radio sidelink technology, but the introduction of this mechanism means that some channels or signals or messages cannot be sent or received for a period of time. Similarly, to save power, partial sensing (partial sensing) and random selection are also introduced in the new radio sidelink technology. However, this means that some channels or signals or messages cannot be sent or received within a period of time (for example, a sensing window (sensing window) or a partial sensing window (partial sensing window), or a time in which no sensing is performed), thereby affecting transmission reliability.

### SUMMARY

Embodiments of this application provide a transmission control method and apparatus, and an electronic device.

According to a first aspect, an embodiment of this application provides a transmission control method, and the method includes:

performing, by a first terminal, any one of the following operations after transmitting a target object:

transmitting an associated resource of the target object;

scheduling or configuring the associated resource of the target object to be within an active time or beyond an inactive time of a first configuration; and

performing a first operation so that the associated resource of the target object is within the active time or beyond the inactive time of the first configuration.

According to a second aspect, an embodiment of this application provides a transmission control apparatus, and the apparatus includes:

a processing module, configured to perform any one of the following operations after a target object is transmitted:

transmitting an associated resource of the target object;

scheduling or configuring the associated resource of the target object to be within an active time or beyond an inactive time of a first configuration; and

performing a first operation so that the associated resource of the target object is within the active time or beyond the inactive time of the first configuration.

According to a third aspect, an embodiment of this application further provides an electronic device, including a processor, a memory, and a program or an instruction that is stored in the memory and that can be run on the processor, where when the program or the instruction is executed by the processor, the steps of the foregoing method are implemented.

According to a fourth aspect, an embodiment of this application provides a readable storage medium. The readable storage medium stores a program or an instruction, and when the program or the instruction is executed by a processor, the steps of the foregoing method are implemented.

According to a fifth aspect, an embodiment of this application provides a chip. The chip includes a processor and a communications interface, the communications interface is coupled to the processor, and the processor is configured to run a program or an instruction to implement the method in the first aspect.

According to a sixth aspect, an embodiment of this application provides an information processing method, and the method includes:

for a target SL resource that meets a first condition in a sidelink SL resource, determining, by a terminal, reporting information of the target SL resource, where

the first condition is: there are at least two feedback resources that meet a first mapping relationship with the target SL resource, and the first mapping relationship is that an interval between the feedback resource and the SL resource is within a preset range.

According to a seventh aspect, an embodiment of this application provides an information processing apparatus, and the apparatus includes:

a processing module, configured to: for a target SL resource that meets a first condition in a sidelink SL resource, determine reporting information of the target SL resource, where

the first condition is: there are at least two feedback resources that meet a first mapping relationship with the target SL resource, and the first mapping relationship is that an interval between the feedback resource and the SL resource is within a preset range.

According to an eighth aspect, an embodiment of this application further provides an electronic device, including a processor, a memory, and a program or an instruction that is stored in the memory and that can be run on the processor, where when the program or the instruction is executed by the processor, the steps of the foregoing method are implemented.

According to a ninth aspect, an embodiment of this application provides a readable storage medium. The readable storage medium stores a program or an instruction, and when the program or the instruction is executed by a processor, the steps of the foregoing method are implemented.

According to a tenth aspect, an embodiment of this application provides a chip. The chip includes a processor and a communications interface, the communications interface is coupled to the processor, and the processor is configured to run a program or an instruction to implement the method in the sixth aspect.

According to an eleventh aspect, an embodiment of this application provides a computer software product. The computer software product is stored in a non-volatile storage medium, and the software product is configured to be executed by at least one processor to implement the steps of the method in the first aspect or the steps of the method in the sixth aspect.

According to a twelfth aspect, an embodiment of this application provides an electronic device. The electronic device is configured to perform the method in the first aspect or the method. in the sixth aspect.

### BRIEF DESCRIPTION OF DRAWINGS

The following describes the accompanying drawings required for describing the embodiments of this application. Apparently, the accompanying drawings in the following description show some embodiments of this application.

FIG. 1 is a schematic diagram of a wireless communications system;

FIG. 2 is a schematic diagram of a Discontinuous Reception (DRX) cycle;

FIG. 3 is a schematic diagram of a Long Term Evolution (LTE) sidelink resource allocation mode 4;

FIG. 4 is a schematic diagram in which a terminal performs partial sensing and performs resource sensing;

FIG. 5 is a schematic diagram in which a terminal determines whether a resource is preempted;

FIG. 6 is a schematic diagram in which subsequent transmission associated with a channel or signal or message is not within a. corresponding active time;

FIG. 7 is a schematic diagram in which an associated resource of a received target object is beyond an active time in which the associated resource of the target object can be received;

FIG. 8 is a schematic diagram in which an associated resource of a received target object is beyond an active time in which the associated resource of the target object can be sent;

FIG. 9 to FIG. 12 are schematic diagrams in which an associated resource of a received target object is beyond an active time in which the associated resource of the target object can be received;

FIG. 13 and FIG. 14 are schematic diagrams in which an associated resource of a received target object is beyond an active time in which the associated resource of the target object can be sent;

FIG. 15 is a schematic flowchart of a transmission control method according to an embodiment of this application;

FIG. 16 to FIG. 20 are schematic diagrams of performing transmission control according to specific embodiments of this application;

FIG. 21 is a schematic structural diagram of a transmission control apparatus according to an embodiment of this application;

FIG. 22 is a schematic diagram of composition of a terminal according to an embodiment of this application; and

FIG. 23 is a schematic diagram in which there are at least two feedback resources corresponding to a target SL resource according to an embodiment of this application.

### DETAILED DESCRIPTION

The following describes the embodiments of this application with reference to the accompanying drawings in the embodiments of this application. Apparently, the described embodiments are some but not all of the embodiments of this application.

In the specification and claims of this application, the terms “first,” “second,” and the like are intended to distinguish between similar objects but do not describe a specific order or sequence. It should be understood that the data used in such a way is interchangeable in proper circumstances so that the embodiments of this application can be implemented in an order other than the order illustrated or described herein. In addition, in the specification and the claims, “and/or” represents at least one of connected objects, and a character “I” generally represents an “or” relationship between associated objects.

The technology described in this specification is not limited to a Long Term Evolution (LTE)/LTE-Advanced (LIE-A) system, and can also be used in various wireless communications systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” are often used interchangeably. The CDMA system may implement wireless technologies such as CDMA2000 and Universal Terrestrial Radio Access (UTRA), UTRA includes Wideband CDMA (WCDMA) and other CDMA variants. The TDMA. system can implement radio technologies such as Global System for Mobile communication (GSM). The OFDMA system can implement radio technologies such as Ultra-Mobile Broadband (UMB), Evolved-UTRA (Evolution-UTRA, E-UTRA), IEEE 802.11 (Wi-Fi), IEEE 802.16 (WiMAX), IEEE 802.20, and Flash-OFDM. UTRA and E-UTRA are parts of a Universal Mobile Telecommunications System (UMTS). LTE and more advanced LTE (for example, LTE-A) are new UMTS versions using E-UTRA, UTRA, E-UTRA, UMTS, LTE, LTE-A, and GSM are described in the literature from an organization called 3rd Generation Partnership Project (3GPP). CDMA2000 and UMB are described in the literature from an organization called “3rd Generation Partnership Project 2” (3GPP2). The technologies described herein can be used both in the systems and radio technologies mentioned above, and can also be used in other systems and radio technologies. However, the following descriptions describe an NR system for example purposes, and NR terms are used in most of the following descriptions, although these techniques can also be applied to an application other than an NR system application.

The following description provides examples without limiting the scope, applicability, or configuration set forth in the claims. The functions and arrangements of the elements under discussion may be changed without departing from the spirit and scope of the present disclosure. In the examples, various procedures or components may be appropriately omitted, replaced, or added. For example, the described method may be performed in an order different from that described, and steps may be added, omitted, or combined. In addition, features described with reference to some examples may be combined in other examples.

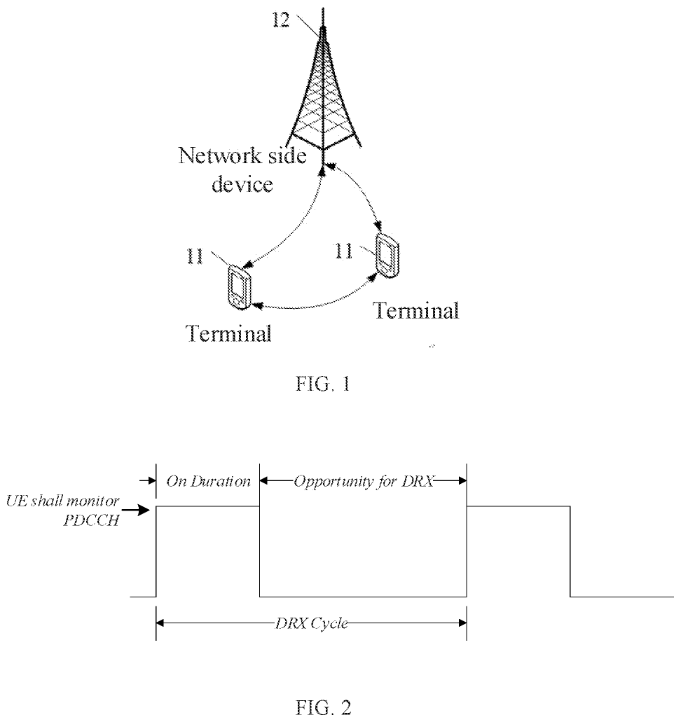

Referring to FIG. 1, FIG. 1 is a block diagram of a wireless communications system to which embodiments of this application can be applied. The wireless communications system includes a terminal 11 and a network side device 12. The terminal 11 may also be referred to as a terminal device to User Equipment (UE). The terminal 11 may be a terminal side device such as a mobile phone, a tablet personal computer, a laptop computer, a Personal Digital Assistant (PDA), a Mobile Internet Device (MID), a. wearable device, or an in-vehicle device. It should be noted that a specific type of the terminal 11 is not limited in the embodiments of this application. The network side device 12 may be a base station or a core network. The base station may be a base station of the 5^{th} Generation (5G) or a later version (for example, a gNB or a 5G NR NB), or a base station in another communications system (for example, an eNB, a Wireless Local Area Network (WLAN) access point, or another access point), or a location server (for example, an Evolved Serving Mobile Location Centre (E-SMLC) or a Location Manager Function (LNIF). The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wireless Fidelity (WiFi) node, or another appropriate term in the art. As long as a same technical effect is achieved, the base station is not limited to a specified technical term. It should be noted that, in the embodiments of this application, only a base station in an NR system is used as an example, but a specific type of the base station and a specific communications system are not limited in the embodiments of this application.

A DRX mechanism is introduced to both Long Term Evolution (LTE) and New Radio (NR). DRX is discontinuous reception, and power saving of a terminal (e.g., UE) is achieved by configuring DRX on and off time. As shown in FIG. 2, onDuration is an interval of DRX on, and the UE enters off duration of a DRX cycle if scheduling is not performed after on duration.

When DRX is configured, parameters such as onDuration Timer, drx-Inactivity Timer, drx-Retransmission Timer, andllongDRX-CycleStartOffset are configured.

After DRX is configured is configured for the UE, if decoding of sent or received data fails, the UE needs to enter an active time to monitor a control channel, and wait for retransmission scheduled by a network.

During onDuration, if the UE is scheduled and receives data in a slot, it is likely that the UE continues to be scheduled in next several slots. Therefore, whenever the LTE is scheduled to initially transmit data, the timer drx-InactivityTimer is started or restarted, and the UE will remain in an active state until the timer expires.

For receiving of downlink data, after receiving a downlink data transmission indicated by a Physical Downlink Control CHannel (PDCCH) and feeding back Hybrid Automatic Repeat re Quest (HARQ) information, the FE starts a downlink backhaul timer (HARQ Round Trip Time (RRT) Timer) for a corresponding HARQ process (e.g., Hybrid Automatic Retransmission). After the HARQ RTT timer expires, if data of the HARQ process is not successfully decoded, the UE starts a retransmission tinier (drx-RetransmissionTimer), monitors a PDCCH, and waits for transmission.

For sending of uplink data, after receiving an uplink data transmission indicated by a PDCCH, the UE starts an uplink backhaul timer HARQ RTT Timer for a corresponding HARQ process. After the HARQ RTT timer expires, the UE starts a retransmission timer (drx-ULRetransmissionTimer), enters an active state to monitor a PDCCH, and waits for transmission scheduled by a network.

Some Uu resources may be used for a SideLink (SL). Renumbering these resources used for SL may be understood as numbering logical times. For example, if a slot ⅓ in 10 continuous slots (assuming that physical times are numbered as slots 0-9) is used for SL, a physical time is numbered as a slot 1/3, and a logical time is numbered as a slot 0/1. A physical time includes continuous time units, and time units in a logical time may be discontinuous or continuous.

An LTE sidelink supports two resource allocation modes: a scheduled resource allocation mode and an autonomous resource selection mode. In the former mode, a network side device controls and allocates a resource to each UE, and in the latter mode, the LTE independently selects a resource. An LTE sidelink resource allocation mode 3 is a scheduled resource allocation mode of Vehicle to everything (V2X), and an LTE sidelink resource allocation mode 4 is an autonomous resource allocation mode of V2X.

A basic working principle of the LIE sidelink mode 4 is as follows:

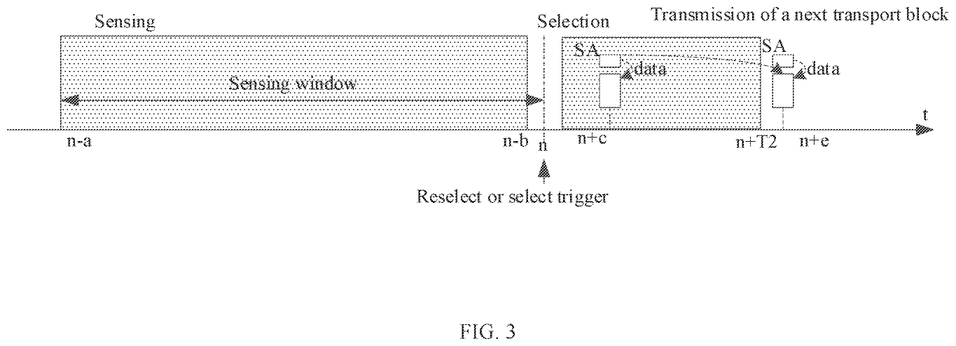

As shown in FIG. 3, measurement is performed in a sensing window, and Scheduling Assignment (SA) and interference measurement are performed in each sensing'Transmission Time interval (TTI). The UE performs resource selection according to the following steps:

(1) A resource for sending data by the UE is excluded.

(2) The terminal demodulates received SA to obtain a resource reserved by other UE, and exclude the resource reserved by other UE.

(3) Measurement sensing is performed in the sensing window, a Reference Signal Strength Indicator (RSSI) is measured, a resource with high interference is excluded according to a measurement result.

(4) In a selection window, a subframe is randomly selected from 20% resources with lowest interference to reserve resources periodically.

Partial sensing in LIE V2X is mainly designed to save power, and is used to support Pedestrian-to-Vehicle (P2V) communication. Pedestrian User Equipment (PUE) supports two resource selection modes. One is random resource selection. The other is to first perform partial sensing, select a resource based on a result of partial sensing, and perform semi-static resource reservation. The PUE chooses which mode is configured for Radio Resource Control (RRC), and when RRC is configured to support the two resource selection modes, the PUE decides which resource selection mode to use.

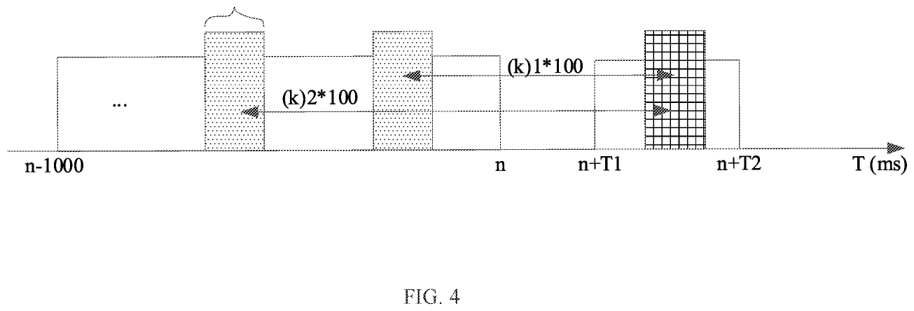

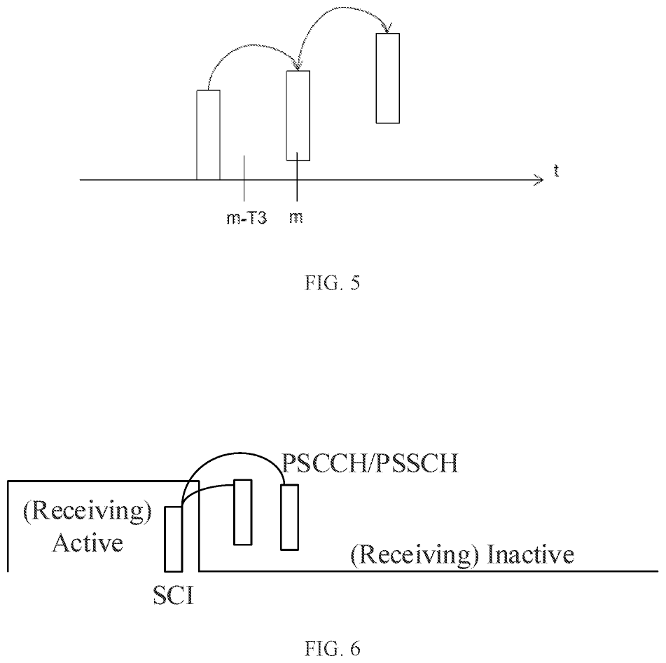

In some implementations, a manner in which the terminal performs partial sensing and performs resource sensing is shown in FIG. 4. A sensing window of the PUE is a dot-filled part in a range of [n-1,000, n], a length Y and k are parameters configured by RRC, and a value range of k may be {1, 2, 3, . . . , 10}. A grid-filled part in [n+T1, n+T2] in the selection window is a selection window of the PUE configured by a higher layer. The PUE senses Sidelink Control Information (SCI) sent by another terminal in the detection window of the dot-filled part, and speculates, according to the sensed SCI and a reservation period, a resource reservation situation of the another terminal in the detection window of the grid-filled part. The HIE may exclude, according to the information, a resource that does not meet the condition in the selection window At least 20% of remaining resources (20% of the window length Y) are selected as a candidate resource set, and reported to a Medium Access Control (MAC) layer. The MAC layer randomly selects a resource from the candidate resource set as a candidate resource of the PUE. The PUE performs periodic reservation on the selected resource, and the reservation period is indicated in the SCI.

If a user performs random selection, a resource is randomly selected within a selection window in FIG. 4, and sensing does not need to be performed.

Two resource allocation modes are defined for an NR SL. One is a mode 1 in which a base station schedules a resource. The other is a mode 2 in which the UE determines which resource to use for transmission.

In the Mode 2 resource allocation mode, resource selection based on sensing is supported. Its principle is similar to a sensing mechanism in an LTE SL mode 4. A specific working manner is as follows:

(1) After resource selection is triggered, transmit (TX) UE first determines a resource selection window, where a lower boundary of the resource selection window is in a T1 time after the resource selection is triggered, and an upper boundary of the resource selection is in a T2 time after the triggering. T2 is a value selected within a Packet Delay Budget (PDB) of a Transport Block (TB) in a manner implemented by the UE, and T2 is not earlier than T1.

(2) Before resource selection, the UE needs to determine a candidate resource set (candidate resource set) for resource selection, and compare a Reference Signal Received Power (RSRP) measured on the resource within the resource selection window with a corresponding RSRP threshold. If the RSRP is less than RSRP threshold, the resource may be included in the candidate resource set.

(3) After the resource set is determined, the UE randomly selects a transmission resource from the candidate resource set. In addition, the UE may reserve a transmission resource for subsequent transmission in this transmission.

In the NR SL of the related art, the TX UE performs resource reservation (reservation is divided into periodical reservation and aperiodic reservation) on resources allocated by the TX UE, and reserved resources are used for subsequent transmission of a Physical Sidelink Control CHannel (PSCCH) and/or a Physical Sidelink Shared CHannel (PSSCH). The aperiodic reservation may be implemented by using a time resource assignment field in Sidelink Control Information (SCI), and reserved resources may be used for transmission of at least a same TB. The periodic reservation may be implemented by using a resource reservation period field in the SCI, and periodic resources reserved in a current period may be used for transmission of a next TB.

In the Mode 2 resource allocation mode, a resource preemption (pre-emption) mechanism is supported. Brief descriptions of the mechanism are as follows: A resource reserved and/or selected by UE overlaps (or partially overlaps) with a resource reserved and/or selected by other UE with a higher priority service. If an SL-RSRP measurement value of the UE on an associated resource is greater than an associated SL-RSRP threshold, the UE triggers resource reselection. The service priority and the SL-RSRP threshold are determined by TB transmission on the resource.

The NR SL supports establishment of an RRC connection, also known as a PC5-RRC connection, for unicast transmission on an SL. An establishment manner is as follows:

(1) UE1 sends a connection establishment message RRCReconfigurationSidelink and start a timer T400.

(2) If a connection establishment complete message RRCReconfigurationCompleteSidelink from UE2 is received within a time of T400, it is considered that connection establishment is successful.

(3) If a connection establishment failure message from the UE2 is received, or if the connection establishment complete message from the UE2 is not received when the T400 expires, it is considered that connection establishment fails.

T400 is a physical time, and a value is {100 ms, 200 ms, 300 ms, 400 ms, 600 ms, 1,000 ms, 1,500 ms, 2,000 ms}.

A user who establishes an SL RRC connection needs to monitor quality of the connection and perform Radio Link Monitoring (RLM). However, when N Discrete Transmissions (DTX) occur, that is, when a Physical Sidelink Feedback CHannel (PSFCH) corresponding to data sent by the user cannot be detected for N times, the user considers that a Radio Link Failure (RLF) occurs.

When an NR SL supports unicast transmission, transmission of an SL Channel State Information Reference Signal (CSI-RS) and feedback of SL Channel State Information (CSI) are performed. A specific implementation method includes:

(1) When establishing an RRC connection on an SL with UE2, the UE1 determines a latency requirement sl-LatencyBound-CSI-Report, and notifies the UE2 of the latency. The latency is defined to indicate a maximum interval between SCI for requesting CSI and a CSI report.

(2) The UE1 sends a CSI-RS and indicate the requested CSI in the SCI.

(3) The UE2 performs a CSI report within this latency. If the UE2 cannot find a resource that meets the latency requirement for sending the CSI report, the UE2 cancels sending of the CSI report.

SI-LatencyBoundCSI-Report is a physical time, and a value is 3-160 slots.

To improve reliability and effectiveness of sidelink transmission, an SL HARQ is introduced to NR V2X. On an SL, a sending node sends a data TB to a receiving node, and the receiving node determines whether the data is successfully received. If the data is successfully received, the receiving node feeds back an ACKnowledgment (ACK) to the sending node; otherwise, feeds back a Negative ACKnowledgment (NACK). The ACK and/or the NACK is transmitted on a corresponding PSFCH resource (that is, corresponding PSFCH).

At present, to save power, SL DRX, partial sensing, and random selection are introduced to an NR SL. At least one of the mechanisms such as SL DRX, partial sensing, and random selection may have restrictions on receiving of some channels or signals or messages, that is, some channels or signals or messages cannot be received within a period of time (for example, during DRX off).

In addition to restrictions on receiving of some channels or signals or messages, at least one of the mechanisms such as SL DRX, partial sensing, and random selection may have restrictions on sending of some channels or signals or messages, that is, some channels or signals or messages cannot be sent within a period of time, thus affecting link monitoring and transmission reliability.

That is, after a user sends or receives a channel or signal or message, the channel or signal or message may be associated with subsequent sending or transmission, and the sending or transmission may not he within a corresponding active time. For example, as shown in FIG. 6, if at least one PSCCH and/or PSSCH resource indicated or reserved by received SCI is not within an active time of (for example, for receiving) a PSCCH and/or PSSCH or within an inactive time, a packet loss may occur, a sensing result is inaccurate, and a calculated Channel Busy Ratio (CBR) or a Channel occupancy Ratio (CR) is inaccurate. Consequently, a selected transmission parameter is inappropriate, and an appropriate resource cannot be selected, and the like.

SL DRX may be performed to control sensing, monitoring, and/or transmission (the transmission includes receiving and sending) of a user to a target object, and the target object includes at least one of the following: SCI (including at least one of 1st stage SCI and 2st stage SCI), a PSSCH, a PSCCH, an SL Reference Signal (RS), a PSSCH, a Sidelink Synchronization Signal and PBCH Block (S-SSB), CSI, a connection establishment response, and the like. In addition to restrictions on transmission of the foregoing signal or channel or message, another signal or channel or message, such as a Positioning Reference Signal (PRS), a Phase Tracking Reference Signal (PTRS), a discovery channel, a discovery signal, an RS request, an RS indication, an RS response, a measurement report, a positioning-related measurement report, a resource request, resource allocation, resource recommendation, and resource scheduling may also be affected by SL DRX.

When an associated resource of a target object is beyond an active time, the problem may be further divided into the following four cases:

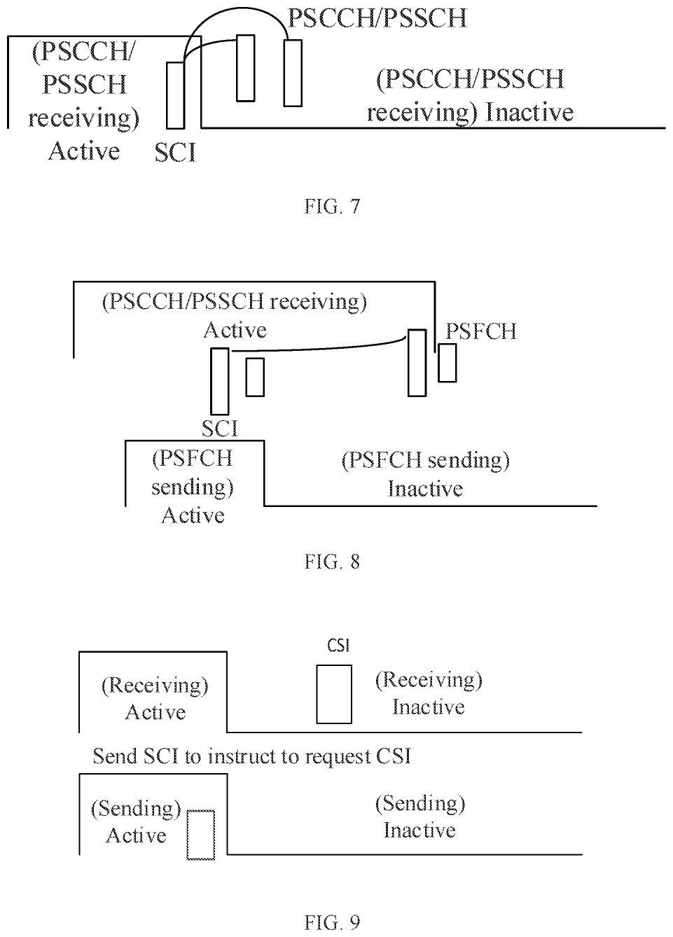

Problem 1: If (for example, the received) associated resource (represented by a square in the figure) of the target object is beyond the active time (for example, the associated resource of the target object may be received), as shown in FIG. 7.

The target object is SCI, and the associated resource of the target object is at least one PSCCH and/or PSSCH resource indicated or reserved by the SCI.

For example, the at least one PSCCH and/or PSSCH resource indicated or reserved by the received SCI is not within an active time of (for example, for receiving) a PSCCH and/or PSSCH or within an inactive time.

If the PSCCH and/or PSSCH (for example, should be received) may result in a packet loss within the above time (for example, for restricting receiving of the PSCCH and/or PSSCH), a sensing result is inaccurate, and a calculated CBR or CR is inaccurate. Consequently, a selected transmission parameter is inappropriate, and an appropriate resource cannot be selected, and the like.

Problem 2: If (for example, the received) associated resource (represented by a square in the figure) of the target object is beyond the active time (for example, the associated resource of the target object may be sent), as shown in FIG. 8. The target object and the associated resource of the target object may be signals, channels, or messages of a same type or different types.

The target object is a Medium Access Control (MAC) Protocol Data Unit (PDU) based on a HARQ feedback, or data and/or control (for example, for which the HARQ feedback is enabled), and the associated resource of the target object is at least one feedback resource or feedback occasion corresponding to the target object.

For example, SCI for which a feedback enabled is received, and the SCI indicates N resources, and a feedback occasion corresponding to at least one of the N resources is beyond an active time of the feedback (for example, may be sent) and/or within an inactive time.

If the feedback (for example, should be received) is within the above time (for example, for restricting receiving of the feedback), whether a packet is transmitted successfully cannot be determined, resulting in decrease in reliability. A peer end user may fail to determine whether the packet is successfully transmitted, resulting in decrease in reliability, and therefore the peer end. user may erroneously determine that an RLF occurs.

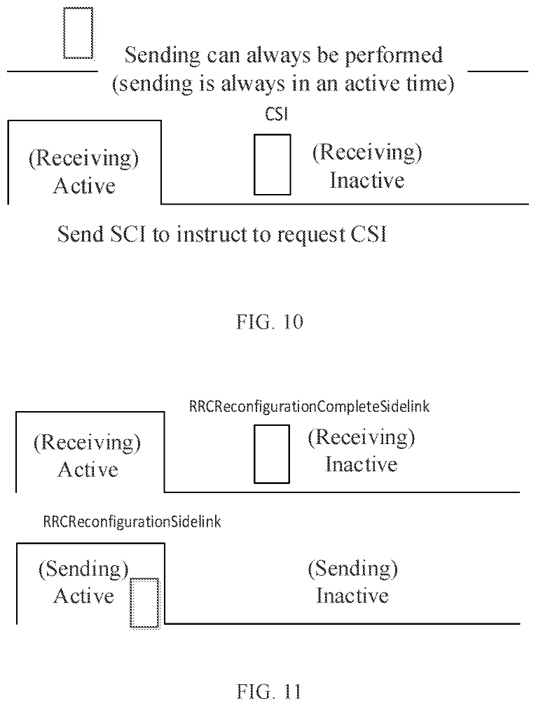

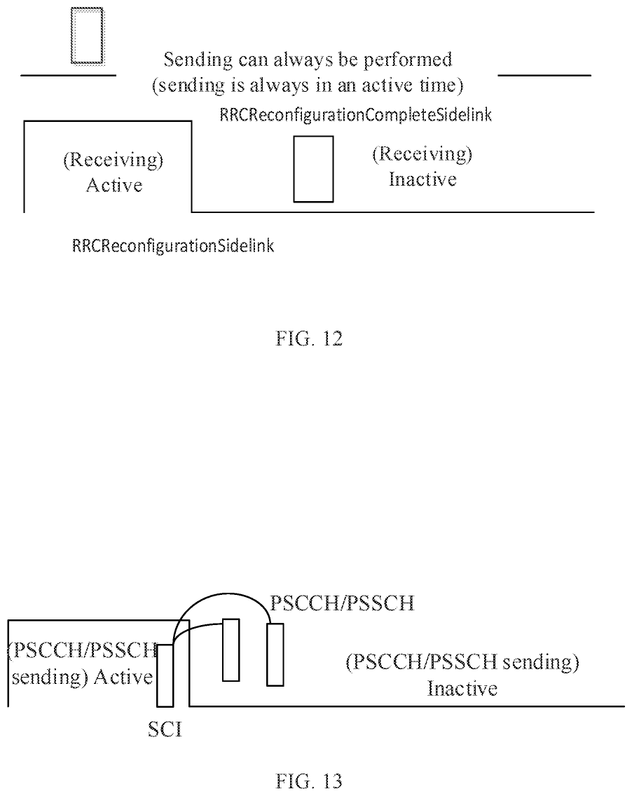

Problem 3: If (for example, the sent) associated resource (represented by a square in the figure) of the target object is beyond the active time (for example, the associated resource of the target object may be received), as shown in FIG. 9 to FIG. 12. The target object and the associated resource of the target object may be signals, channels, or messages of a same type or different types. As shown in FIG. 9, the target object is a CSI request, the associated resource of the target object is a resource occupied by a CSI report, the CSI request is sent at an active time for sending, and the CSI report is an inactive time for receiving. As shown in FIG. 10, sending is always in an active time or an active time and an inactive time are not distinguished for sending, the target object is a CSI request, the associated resource of the target object is a resource occupied by a CSI report, and the associated resource of the target object is in an inactive time for receiving. As shown in FIG. 11, the target object is a connection establishment message RRCReconfigurationSidelink, the associated resource of the target object is a connection establishment response message RRCReconfigurationCompleteSidelink, the target object is in an inactive time for sending, and the associated resource of the target object is in an inactive time for receiving. As shown in FIG. 12, the target object is a connection establishment message RRCReconfigurationSidelink, the associated resource of the target object is a connection establishment response message RRCReconfigurationCompieteSidelink, sending is always in an active time or an active time and an inactive time are not distinguished for sending, and the associated resource of the target object is in an inactive time for receiving.

(a) The target object is a request of an RS or a request of a channel, and the associated resource of the target object is a requested RS or channel.

For example, a request of a CSI-RS or a PRS is sent, and the CSI-RS or the PRS sent by the peer end is beyond an active time of (for example, for receiving) the CSI-RS or the PRS/is within an inactive time. The PRS may also be referred to as a positioning RS, and may be a Sounding Reference Signal (SRS), a CSI-RS, or another RS used for positioning.

(b) The target object is a CSI request, and the associated resource of the target object is a CSI report.

For example, the CSI request is sent, and the CSI report returned by the peer end is beyond an active time of (for example, for receiving) the CSI report (for example, an active time corresponding to data and/or control)/is within an inactive time.

(c) The target object is a connection establishment message RRCReconfigurationSidelink, and the associated resource of the target object is a connection establishment response message RRCReconfigurationCompleteSidelink,

For example, the connection establishment message is sent, and the connection establishment response message returned by the peer end is beyond an active time of (for example, for receiving) the connection establishment response message or is within an inactive time.

If the connection establishment response message (for example, should be received) is within the above time (for example, for restricting receiving of the connection establishment response message), it cannot be determined whether a connection is established successfully.

The CSI report may not be received if the CSI report (for example, should be received) is within the above time (for example, for restricting receiving).

Problem 4: If (for example, the sent) associated resource (represented by a square in the figure) of the target object is beyond the active time (for example, the associated resource of the target object may be sent), as shown in FIG. 13 to FIG. 14. The target object and the associated resource of the target object may be signals, channels, or messages of a same type or different types.

(a) The target object is SCI, and the associated resource of the target object s at least one PSCCH and/or PSSCH resource indicated or reserved by the SCI.

For example, the at least one PSCCH and/or PSSCH resource (for example, may be used for subsequent sending) indicated or reserved by the sent SCI is beyond an active time of (for example, for sending) a PSCCH and/or PSSCH/within an inactive time. If the PSCCH and/or

PSSCH (for example, should be sent) is within the above time (restricted for sending of the PSCCH and/or PSSCH), a transmission failure may occur and/or a peer end user misunderstands a transmission resource of a packet.

(b) The target object is indication information, and the associated resource of the target object is at least one signal or channel or message indicated by the indication information.

For example, at least one sequence or RS (that may need to be sent) indicated by the sent indication information SCI is beyond an active time of (for sending) the sequence or RS/is within an inactive time.

In the foregoing problems 1 to 4, the target object and the associated resource of the target object may be signals or channels or messages of a same type or different types. In the foregoing problems 1 to 4, the target object and the associated resource of the target object may be a same transmission. For example, if one pieces of SCI indicates a resource in which the SCI is located, the target object and the associated resource of the target object are both the SCI. A plurality of the foregoing problems 1 to 4 may occur at the same time.

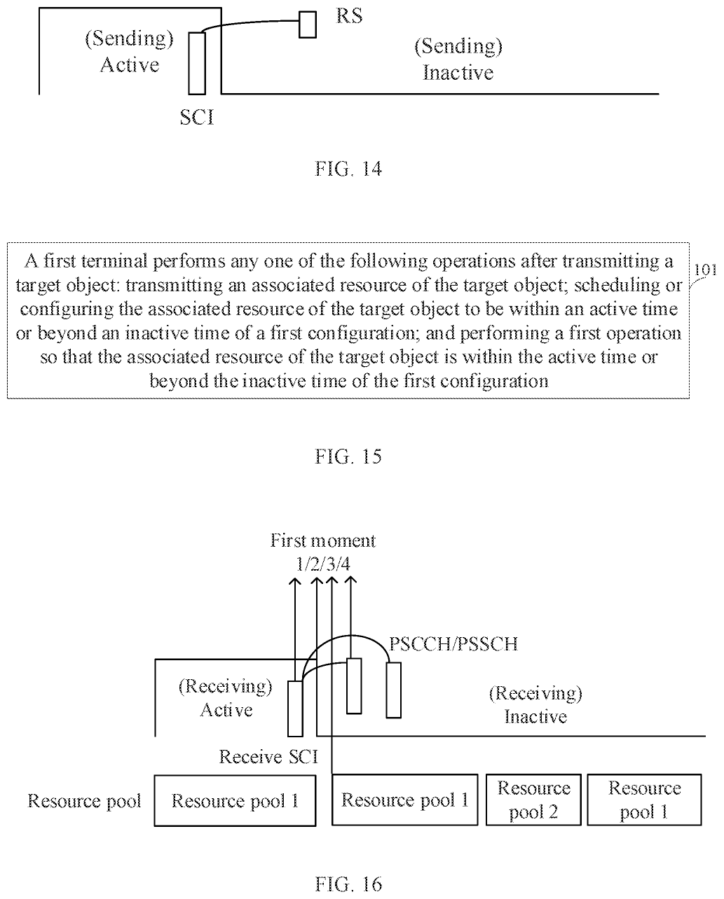

An embodiment of this application provides a transmission control method. As shown in FIG. 15, the method includes the following steps.

Step 101: A first terminal performs any one of the following operations after transmitting a target object:

transmitting an associated resource of the target object;

scheduling or configuring the associated resource of the target object to be within an active time or beyond an inactive time of a first configuration; and

performing a first operation so that the associated resource of the target object is within the active time or beyond the inactive time of the first configuration.

In this embodiment of this application, after transmitting a target object, a. terminal transmits an associated resource of the target object, and/or schedules or configures the associated resource of the target object to be within an active time or beyond an inactive time of a first configuration, and/or performs a first operation so that the associated resource of the target object is within the active time or beyond the inactive time of the first configuration. In this way, the associated resource of the target object can continue to be transmitted, thereby ensuring consistent understanding between a transmit end and a receive end and improving transmission reliability.

The first terminal may be a terminal in sidelink transmission, and the transmission includes sending and receiving. The first configuration may be DRX, and the DRX may include an active time and an inactive time, and may further include a time period other than the active time and the inactive time. Within an active time of SL DRX, a terminal measures, monitors, and/or transmits the target object, and does not measure, monitor, and/or transmit the target object within an inactive time.

The active time and the inactive time may be defined for the target object, that is, active times of different target objects may be the same or different, and inactive times of different target objects may be the same or different. The active time and the inactive time may be alternatively defined for a transmission direction, that is, an active time for sending and an active time for receiving may be the same or different, an inactive time for sending and an inactive time for receiving may be the same or different, and some other target objects or transmission directions may have only an active time and no inactive time. For example, it is assumed that control and/or data may be sent at any time, but receiving of the control and/or data is limited to an active time (for example, on duration) of DRX, and the control and/or data may be sent at an active time and an inactive time (for example, off duration), that is, for sending of the control and/or data, it may be understood that no inactive time corresponds to sending of the control and/or data.

The active time includes at least one of on duration, an inactivity timer running time (when inactivity timer is running), a retransmission timer running time (when retransmission timer is running), a T400 running time, and a sidelink latency bound (sl-LatencyBound) CSI-Report period.

The inactive time includes at least one of off duration, a Round Trip Time (RTT) timer running time, a non-partial sensing window part (for example, between partial sensing windows), or a non-sensing time.

The technical solution in this embodiment of this application is not only applicable to partial sensing, but also applicable to sensing. In addition, the technical solution in this embodiment of this application may be applied to a sidelink, but is not limited to the sidelink, and may be further applied to transmission of another type.

In the case of Vehicle to Pedestrian (V2P), sending by a vehicle device (for example, a vehicle terminal (e.g., Vehicle User Equipment (VUE))) needs to be ensured within a sensing window or on duration/active time of a pedestrian device (for example, PUE). In the case of any pedestrian device (in a case that a sent request requires a reply from the in-vehicle device, the pedestrian device needs to show an identity (for example, PUE) and a corresponding time limit requirement (for example, DRX on duration and CSI latency), the partial sensing window may also need to be notified.

In the technical solution in this embodiment of this application, a method for obtaining all information includes at least one of the following:

obtaining a configuration of a base station by a terminal, scheduling or indication by a scheduling terminal, pre-configuration, inter-terminal negotiation, protocol stipulation, and determining by the terminal itself.

In some embodiments, the target object and/or the associated resource of the target object include/includes at least one of the following:

control information, such as an SCI, where the SCI includes at least one of 1st stage SCI and 2nd stage SCE

a physical shared channel, such as a PSSCH;

a physical control channel, such as a PSCCH;

a reference signal RS, such as an SLRS;

a sequence;

a physical feedback channel, such as a PSFCIE

a synchronization signal block, such as an S-SSB;

channel state information CSE

a CSI report;

a connection establishment request;

a connection establishment response;

a connection establishment failure message;

a connection re-establishment request;

a connection re-establishment response;

a positioning reference signal PRS;

a phase tracking reference signal PTRS;

a discovery channel;

a discovery signal;

an RS request;

a sequence request;

an RS indication;

a sequence indication;

an RS response;

a sequence response;

a measurement report of a reference signal, such as a measurement report of Reference Signal Received Quality (RSR( ) a Received Signal Strength Indicator (RSSI), a Signal to Interference plus Noise Ratio (SINR, or signal to noise and interference ratio), and a Signal Noise Ratio (SNR);

a positioning measurement report;

a resource request message;

a resource allocation message; and

a resource recommendation message.

The target object and the associated resources of the target object may be signals or channels or messages of a same type or different types, and the associated resource of the target object is a resource occupied by at least one of the foregoing.

In some embodiments, the target object is control information, and the associated resource of the target object is at least one data resource and/or control resource indicated or reserved by the control information; and/or

the target object is a MAC VDU or a TB or a packet or data or control signaling based on a HARQ feedback, and the associated resource of the target object is at least one feedback resource or feedback occasion corresponding to the target object; and/or

the target object is a request message, and the associated resource of the target object is a response to the request message; and/or

the target object is a reference signal or a sequence, and the associated resource of the target object is a measurement report; and/or

the target object is indication information, and the associated resource of the target object is at least one signal or channel or message indicated by the indication information.

That LTE A sends an RS and LTE B feeds back a measurement report may be considered as an alternative request and response.

In some embodiments, the target object is a request of an RS or a request of a channel or a request of a message, and the associated resource of the target object is a response to the request message, for example, a requested RS or channel or message; and/or

the target object is a measurement request, and the associated resource of the target object is a measurement report, where for example, the target object is a CSI request, and the associated resource of the target object is a resource occupied by a CSI report; and/or

the target object is a connection establishment request, and the associated resource of the target object is a connection establishment response; and/or

the target object is a connection re-establishment request, and the associated resource of the target object is a connection re-establishment response.

In some embodiments of this application, when at least one of the foregoing problems 1 to 4 occurs, the associated resource of the target object may be still transmitted. The transmitting an associated resource of the target object includes any one of the following:

starting a first timer at a first moment, and transmitting the associated resource of the target object;

transmitting a preset quantity of or all associated resources of the target objects; and

transmitting the preset quantity of or all first associated resources of the target objects, where the first associated resource is beyond the active time or within the inactive time.

After the first timer is started, the associated resource of the target object may be transmitted within a running time of the first timer. The running time of the first timer may be within the active time or beyond the inactive time.

In some embodiments, the first timer may be started at the first moment, and

the first moment includes a time point corresponding to a first object, and the first object includes at least one of the following:

the target object;

the associated resource of the target object;

an active time for the target object; and

the earliest resource in a resource pool in which the target object is located after the active time for the target object.

The time point corresponding to the first object may be a time point at which the first object is located, or may be shifted from the time point at which the first object is located, for example, being shifted forward or backward.

In some embodiments, if the first object includes a plurality of target objects, the first moment is a time point corresponding to the latest target object in the plurality of target objects; or if the first object includes the associated resource of the target object, a plurality of first associated resources of the target object are beyond the active time or within the inactive time, and the first moment is a time point corresponding to the earliest associated resource in the plurality of first associated resources.

In some embodiments, the associated resource of the target object is a feedback occasion or a feedback resource corresponding to the target object.

In some embodiments, the first moment is a time point corresponding to the earliest associated resource in the associated resources of the target object.

The earliest may mean the earliest in time domain.

In some embodiments, the time point corresponding to the first object is any one of the following:

a start point of a time domain resource of the first object;

an end point of the time domain resource of the first object;

a time point of the first n1 time units of the time domain resource of the first object; and

a time point of the last n2 time units of the time domain resource of the first object, where

n1 and n2 are natural numbers.

In a specific example, to resolve the problem 1, the first moment may be:

(1) A time point at which the target object is located. In some implementations, if there are a plurality of target objects, the time point at which the target object is located is a time point at which a latest target object is located.

(2) An end time point of an active time in which the target object is located (for example, the target object may be received).

(3) An earliest resource in a resource pool in which the target object is located after the active time in which the target object is located (for example, the target object may be received).

(4) A time point at which an earliest associated resource in associated resources of the target object is located, which may be a time point at which the earliest associated resource in the associated resources of the target object beyond the active time or within the inactive time is located. In some implementations, if a plurality of target objects have associated resources beyond the active time or within the inactive time, the time point at which the earliest associated resource in the associated resources of the target object beyond the active time or within the inactive time is located is a time point at which the earliest associated resource in these associated resources beyond the active time or within the inactive time is located.

As shown in FIG. 16, if the target object is SCI, the associated resource of the target object is at least one PSCCH and/or PSSCH resource indicated or reserved by the SCI, and the last two of three resources indicated by the received SCI are beyond an active time for receiving or are not in a current active time window, for example, not within on duration, In this case, the first moment at which the first timer is started may be a time corresponding to 1/2/3/4 in the figure, which respectively corresponds to the foregoing (1) to (4).

In a specific example, to resolve the problem 2, the first moment may be:

(1) A time point at which the target object is located. In some implementations, if there are a plurality of target objects, the time point at which the target object is located is a time point at which a latest target object is located.

(2) A time point at which an earliest associated resource in associated resources of the target object is located. In some implementations, the associated resource of the target object is a feedback opportunity or a feedback resource corresponding to the target object,

(3) An end time point of an active time in which the target object is located (for example, the target object may be received).

(4) An earliest resource in a resource pool in which the target object is located after the active time in which the target object is located (for example, the target object may be received).

(5) A time point at which an earliest associated resource in associated resources of the target object is located, which may be a time point at which the earliest associated resource in the associated resources of the target object beyond the active time or within the inactive time is located. In some implementations, if a plurality of target objects have associated resources beyond. the active time or within the inactive time, the time point at which the earliest associated resource in the associated resources of the target object beyond the active time or within the inactive time is located is a time point at which the earliest associated resource in these associated resources beyond the active time or within the inactive time is located.

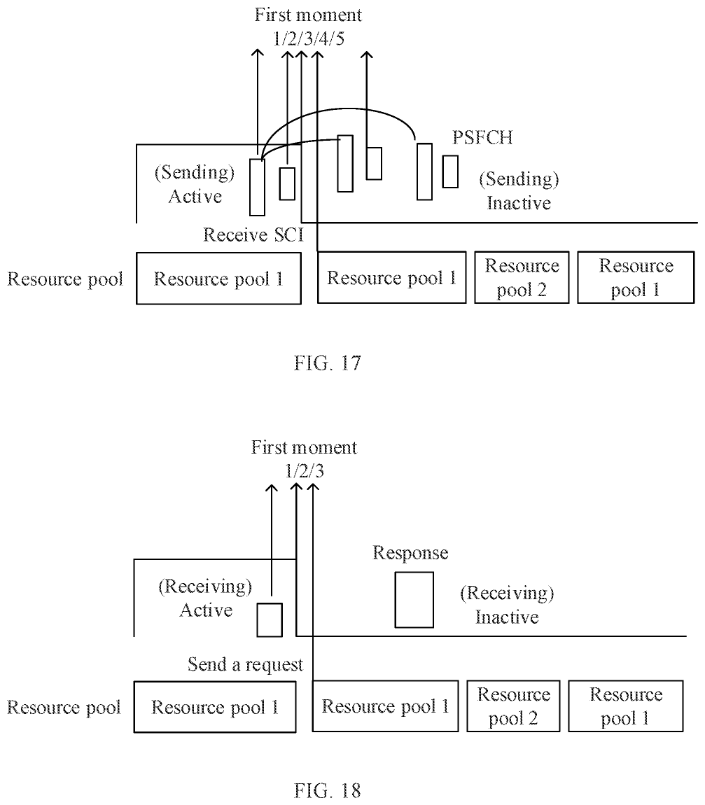

As shown in FIG. 17, if the target object is a MAC PDU based on a HARQ feedback, or data and/or control signaling (for example, for which the HARQ feedback is enabled), the associated resource of the target object is at least one feedback resource or feedback occasion corresponding to the target object, and feedback occasions corresponding to the last two of three resources indicated by the received SCI are beyond an active time for receiving or are not in a current active time window, for example, not within on duration. In this case, the first moment at which the first timer is started may be a time corresponding to 1/2/3/4/5 in the figure, which respectively corresponds to the foregoing (1) to (5).

In some examples, to resolve the problem 3, the first moment may be:

(1) A time point at which the target object is located, In some implementations, if there are a plurality of target objects, the time point at which the target object is located is a time point at which a latest target object is located.

(2) An end time point of an active time in which the target object is located (for example, the target object may be received).

(3) An earliest resource in a resource pool in which the target object is located after the active time in which the target object is located (for example, the target object may be received).

As shown in FIG. 18, the target object is a request of an RS or a request of a channel, and the associated resource of the target object is a requested RS or channel. Alternatively, for example, the target object is a CSI request, and the associated resource of the target object is a CSI report, or for example, the target object is a connection establishment message RRCReconfigurationSidelink, and the associated resource of the target object is a connection establishment response message RRCReconfigurationCompleteSidelink. After a request is sent, a response of a peer end is beyond an active time for receiving or is not in a current active time window, for example, not within on duration. In this case, the first moment at which the first timer is started may be a time corresponding to 1/2/3 in the figure, which respectively corresponds to the foregoing (1) to (3).

In some examples, to resolve the problem 4, the first moment may be:

(1) A time point at which the target object is located. In some implementations, if there are a plurality of target objects, the time point at which the target object is located is a time point at which a latest target object is located.

(2) An end time point of an active time in which the target object is located (for example, the target object may be received).

(3) An earliest resource in a resource pool in which the target object is located after the active time in which the target object is located (for example, the target object may be received).

(4) A time point at which an earliest associated resource in associated resources of the target object is located, which may be a time point at which the earliest associated resource in the associated resources of the target object beyond the active time or within the inactive time is located. In some implementations, if a plurality of target objects have associated resources beyond the active time or within the inactive time, the time point at which the earliest associated resource in the associated resources of the target object beyond the active time or within the inactive time is located is a time point at which the earliest associated resource in these associated resources beyond the active time or within the inactive time is located.

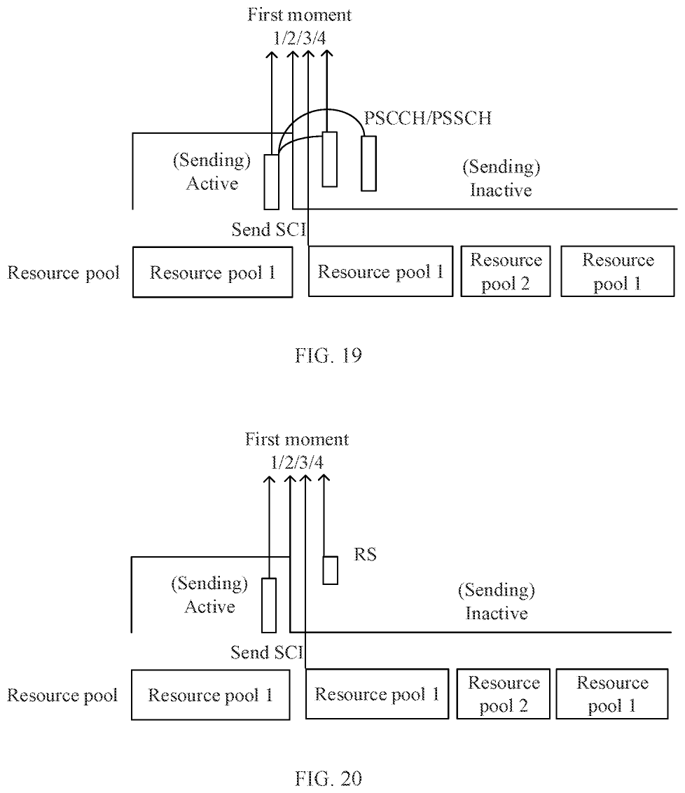

As shown in FIG. 19, for example, the target object is SCI, and the associated resource of the target object is at least one PSCCH and/or PSSCH resource indicated or reserved by the SCI. It is assumed that the last two of three resources indicated by the sent SCI are beyond an active time of a PSCCH and/or a PSSCH (for example, may be sent). In this case, the first moment at which the first timer is started may be a time corresponding to 1/2/3/4 in the figure, which respectively corresponds to the foregoing (1) to (4).

As shown in FIG. 20, for example, the target object is indication information, and the associated resource of the target object is at least one signal or channel or message indicated by the indication information. It is assumed that, for example, an RS indicated by the sent indication information SCI is beyond an active time or within an inactive time of the RS. In this case, the first moment at which the first timer is started may be a time corresponding to 1/2/3/4 in the figure, which respectively corresponds to the foregoing (1) to (4).

In this embodiment of this application, the running time of the first timer may be considered as a part of the active time, that is, the active time is prolonged by starting the first timer, so that associated transmission of the target object can be normally performed.

In some embodiments, one or more measurement reports in RS measurement (for example, periodic measurements and/or event start measurements) and/or (for example, a periodic measurement report and/or an event start measurement report) measurement reports may be within the inactive time or beyond the active time. In order to avoid this situation, the method further includes any of the following:

if a periodical timer is within the inactive time after expiry or stopping, not enabling the periodical timer;

if a time of the periodical timer overlaps the inactive time after the periodical timer is enabled within the active time, not enabling the periodical timer or not triggering the associated procedure of the associated resource of the target object;

suspending the periodical timer if the periodical timer enters the inactive time during running, and continuing running the periodical timer after entering the active time again, or not triggering an associated procedure of the associated resource of the target object; and

clearing or stopping the periodical timer if the periodical timer enters the inactive time during running, and enabling the periodical timer after entering the active time again.

In some embodiments, the target object may be a reference signal, and the associated resource of the target object is a measurement report.

In some embodiments, after the clearing or stopping the periodical timer, any one of the following is performed:

remaining a report count unchanged; and

generating a measurement report based on some reference signals received within the active time and/or increasing the report count, for example, increasing the report count by one.

In some examples, if the periodical timer enters the inactive time during running, the periodical timer is cleared or stopped, the report count remains unchanged, and the periodical timer is enabled after entering the active time. In another example, if the periodical timer enters the inactive time during running, the periodical timer is cleared or stopped, the measurement report is generated based on some RSs received in the active time, the report count plus 1, and the periodical timer is enabled after entering the active time again.

In this embodiment of this application, the foregoing problems 1 to 4 can be avoided during resource selection. For example, a network side device (for example, a base station) is properly configured to avoid the foregoing problems 1 to 4, or a scheduling terminal ensures that the foregoing problems 1 to 4 will not occur, or a peer terminal ensures that the foregoing problems 1 to 4 will not occur, or a terminal 1 itself guarantees that the foregoing problems 1 to 4 will not occur.

In some embodiments, the scheduling or configuring the associated resource of the target object to be within an active time or beyond an inactive time of a first configuration includes at least one of the following:

receiving configuration information of a network side device, where the configuration information indicates that the associated resource of the target object is within the active time or beyond the inactive time;

receiving first indication information of a second terminal, where the first indication information indicates that the associated resource of the target object is within the active time or beyond the inactive time, transmission is performed between the second terminal and the first terminal, and the second terminal a peer terminal;

receiving second indication information of a third terminal, where the second indication information indicates that the associated resource of the target object is within the active time or beyond the inactive time, the third terminal schedules or instructs transmission of the first terminal, and the third terminal is a scheduling terminal;

scheduling the associated resource of the target object to be within the active time or beyond the inactive time; and

sending third indication information to the second terminal, where the third indication information indicates that the associated resource of the target object is within the active time or beyond the inactive time.

In some embodiments, that the first terminal ensures that the associated resource of the target object is within the active time or beyond the inactive time needs to meet at least one of the following: the associated resource of the target object is scheduled to be within the active time or beyond the inactive time; and/or the third indication information is sent to the second terminal, where the third indication information indicates that the associated resource of the target object is within the active time or beyond the inactive time.

In some embodiments, the first indication information and/or the second indication information and/or the third indication information indicate/indicates one or more resources in a time domain resource set within the active time or beyond the inactive time.

The time domain resource set is obtained after a third resource is excluded, the third resource is within the inactive time or beyond the active time, or an associated resource of the third resource is within the inactive time or beyond the active time. In an implementation, the inactive time is first excluded, and after resource cascading is performed on the active timed, resources are indicated based on a cascaded set, for example, if a determined candidate resource is located in a slot 1/2/3/4/5, but the slot 4 is in the inactive time, resource indication is performed based on the slot 1/2/3/5. For example, when the resource indicates the fourth slot, the resource actually corresponds to the slot 5.

In this embodiment, the following resources are not indicated to the terminal: a esource beyond the active time or within the inactive time, or a feedback resource and/or a feedback occasion corresponding to the resource beyond the active time or within the inactive time (for example, transmission or feedback may be performed or may not be performed on the resource beyond the active time or within the inactive time, but the terminal 1 or the peer terminal cannot know).

For example, if the peer end selects a plurality of PSCCH and/or PSSCH resources, and some PSCCH and/or PSSCH resources are beyond an active time and/or within an inactive time of a PSCCH and/or a PSSCH (for example, the terminal 1 performs corresponding receiving), when the peer terminal (for example, a transmit terminal) of the terminal 1 sends a resource within the active time, SCI of the resource within the active time does not indicate the resource beyond the active time or within the inactive time. Therefore, the terminal 1 cannot know that the problem 1 occurs even if the peer terminal uses the resource beyond the active time or within the inactive time.

Similarly, if the terminal selects a plurality of PSCCH and/or PSSCH resources, and some PSCCH and/or PSSCH resources are beyond an active time and/or within an inactive time of a PSCCH and/or a PSSCH (for example, the peer terminal of the terminal 1 performs corresponding receiving), when the terminal I sends a resource within the active time, SCI of the resource within the active time does not indicate the resource beyond the active time or within the inactive time. Therefore, the peer terminal 1 cannot know that the problem 1 occurs.

In some embodiments, the transmitting an associated resource of the target object includes at least one of the following:

obtaining a terminal type of the first terminal, and transmitting the associated resource of the target object within the active time or beyond the inactive time of the first configuration corresponding to the terminal type of the first terminal;

obtaining latency information of the first terminal, and transmitting the associated resource of the target object within the active time or beyond the inactive time of the first configuration according to the latency information;

obtaining a terminal type of a second terminal, transmitting the associated resource of the target object within the active time or beyond the inactive time of the first configuration corresponding to the terminal type of the second terminal, and performing transmission between the second terminal and the first terminal;

obtaining latency information of the second terminal, and transmitting the associated resource of the target object within the active time or beyond the inactive time of the first configuration according to the latency information;

excluding a first resource from a resource selection window or a candidate resource, where the first resource is beyond the active time or within the inactive time and an associated resource of the first resource is beyond the active time or within the inactive time, or the first resource is within the active time or beyond the inactive time and an associated resource of the first resource is beyond the active time or within the inactive time, or the first resource is beyond the active time or within the inactive time and an associated resource of the first resource is within the active time or beyond the inactive time; and

not selecting a second resource for transmitting the associated resource of the target object, where the second resource is beyond the active time or within the inactive time and an associated resource of the second resource is beyond the active time or within the inactive time, or the second resource is within the active time or beyond the inactive time and an associated resource of the second resource is beyond the active time or within the inactive time, or the second resource is beyond the active time or within the inactive time and an associated resource of the second resource is within the active time or beyond the inactive time.

In some embodiments, the associated resource of the target object is transmitted by a remaining resource after the first resource is excluded from the resource selection window or the candidate resource.

In some embodiments, the latency information includes latency duration and/or an offset of the latency duration.

In some embodiments, the latency duration meets any one of the following:

being less than or equal to a length of the active time;

being less than or equal to a length of a remaining active time after an associated time point of the target object;

at least a part of a time period between an associated time point of sending the target object and an end point corresponding to the latency duration is within the active time or beyond the inactive time; and

at least a pail of a time period between the associated time point of sending the target object and expiry of a preset timer is within the active time or beyond the inactive time.

An associated time point may be the time point at which the target object is located, or an offset from the time point at which the target object is located, for example, forward or backward for a period of time.

In some embodiments, the target object is a request message, the associated resource of the target object is a response message, and the latency duration meets any one of the following:

being less than or equal to a length of the active time; being less than or equal to a length of a remaining active time after an associated time point of the request message;

at least a part of a time period between an associated time point of sending the request message and an end point corresponding to the latency duration is within the active time or beyond the inactive time; and

at least a part of a time period between the time point of sending the request message and expiry of a preset timer is within the active time or beyond the inactive time.

In a specific example, the scheduling terminal or the peer terminal ensures that the associated resource of the target object of the terminal 1 is within the active time or beyond the inactive time. in this case, the terminal 1 receives the target object, and the method includes at least one of the following:

(1) A terminal type of the terminal 1 is obtained, and a configuration or a parameter corresponding to the type is used. For example, it is learned that the type of the terminal 1 PUE, to perform sending or responding within an active time of :DRX corresponding to the PUE.

(2) After request information is received, a response message is sent within the active time.

In some implementations, the terminal 1 expects to receive a response of the peer terminal within an active time in which the request is sent, or the terminal 1 expects to receive a response of the peer terminal within an active time after the request is sent.

For example, after the peer terminal receives an RRC connection establishment request, the peer terminal returns response information to the terminal 1 within on duration within T400, where the response information may be RRCReconfigurationCompleteSidelink or RRCReconfigurationFailureSidelink.

(3) A latency requirement of the terminal 1 is obtained, and transmission is adjusted according to the latency requirement. For example, it is learned that T400=length of on duration and an offset of T400 is enabled, and a resource in a time period T400 after a time point corresponding to the offset is obtained, to send the response information.

(4) The following resource is not a candidate resource, or the following resource is excluded from the selection window:

The resource itself or an associated resource of the resource is not within the active time (for example, corresponding sending or receiving of the terminal 1) or is within the inactive time.

(5) The following resource is not selected:

The resource itself or an associated resource of the resource is not within the active time (for example, corresponding sending or receiving of the terminal 1) or is within the inactive time.

In another specific example, the scheduling terminal or the terminal 1 ensures that the associated resource of the target object of the terminal 1 is within the active time or beyond the inactive time. In this case, the terminal 1 sends the target object, and the method includes at least one of the following:

(1) A terminal type of the terminal I is notified, for example, the type (TUI) of the terminal 1 is notified, and the peer end performs sending or responding within an active time of DRX corresponding to the PUE.

(2) A reasonable latency requirement enables that a time point from a requested time point to expiry of the latency requirement (or a focus of the latency requirement) is within the active time.

In some implementations, the latency requirement≤length of the active time, or the latency requirement≤length of a remaining active time after a time point for the request.

In some implementations, the latency requirement is notified, and the requirement includes the latency duration and/or the offset of the latency duration.

For example, the terminal determines a reasonable latency bound of CSI, so that a time period from a time point for sending a CSI request to expiry (end point) of the latency bound is within an active time (for receiving).

In some implementations, the UE for which DRX is activated and/or configured and/or enabled determines a latency bound for DRX. In some implementations, the latency bound is shorter than a latency bound for which DRX is not activated and/or configured and/or enabled.

For example, appropriate T400 is configured for PUE, so that a time period from a time point of sending an RRC connection establishment request to expiry of T400 expires is within an active time (for receiving).

In some implementations, for the PUE, T400 for DRX is configured or preconfigured. In some implementations, T400 is shorter than T400 for which DRX is not activated and/or configured and/or enabled.

For example, T400=length of an active time, or is equal to a length of a remaining active time after a time point for the request.

(3) The following resource is not a candidate resource, or the following resource is excluded from the selection window:

The resource itself or an associated resource of the resource is not within an active time (corresponding sending or receiving of the terminal 1) or is within an inactive time.

(4) The following resource is not selected:

The resource itself or an associated resource of the resource is not within an active time (corresponding sending or receiving of the terminal 1) or is within an inactive time.

According to the foregoing technical solutions, transmission on a resource that causes the problem 1 to 4 can be avoided, thereby avoiding the problems 1 to 4.

In a specific embodiment, for the problem 1, the transmission control method in this embodiment of this application includes at least one of the following:

(1) A resource that is not within an active time (for example, for receiving by the terminal 1) or is within an inactive time does not belong to candidate resources, or is excluded from a selection window.

For example, when the peer terminal determines a resource for sending, the resource that is not within the active time (for example, for receiving by the terminal 1) or is within the inactive time does not belong to candidate resources of the peer terminal, or is excluded from the selection window, so that the peer terminal does not select a resource that causes the problem to transmit the target object.

For example, when the scheduling terminal schedules a resource for sending for the peer terminal, the resource that is not within the active time (for example, for receiving by the terminal 1) or is within the inactive time does not belong to candidate resources that can schedule the peer terminal to perform sending, or is excluded from the selection window, so that the scheduling terminal does not select a resource that causes the problem 1 for the peer terminal to transmit the target object.

(2) A resource that is not within an active time (for example, for receiving by the terminal 1) or is within an inactive time is not selected.

For example, when selecting a resource for sending from candidate resources, the peer terminal does not select the resource that is not within the active time (for example, for receiving by the terminal 1) or is within the inactive time, so that the peer terminal does not select a resource that causes the problem 1 to transmit the target object.

For example, when selecting a resource for sending for the peer terminal, the scheduling terminal does not select the resource that is not within the active time (for example, for receiving by the terminal 1) or is within the inactive time, so that the scheduling terminal does not select a resource that causes the problem I for the peer terminal to transmit the target object.

In another specific embodiment, for the problem 2, the transmission control method in this embodiment of this application includes at least one of the following:

(1) A resource that is not in an active time (for example, for sending by the terminal 1) or is in an inactive time in corresponding feedback occasions or feedback resources does not belong to candidate resources, or is excluded from a selection window.

For example, when the peer terminal determine a resource for sending, the resource that is not within the active time (for example, for sending by the terminal 1) or is within the inactive time does not belong to candidate resources of the peer terminal, or is excluded from the selection window, so that the peer terminal does not select a resource that causes a problem to transmit the target object.

For example, when the scheduling terminal schedules a resource for sending for the peer terminal, the resource that is not within the active time (for example, for sending by the terminal 1) or is within the inactive time does not belong to candidate resources that can schedule the peer terminal to perform sending, or is excluded from the selection window, so that the scheduling terminal does not select a resource that causes the problem 1 for the peer terminal to transmit the target object.

(2) A resource that is not within an active time (for example, for sending by the terminal 1) or is within an inactive time in corresponding feedback occasions or feedback resources is not selected.

For example, when the peer terminal selects a resource for sending from candidate resources, the peer terminal does not select the resource that is not within the active time (for example, for sending by the terminal 1) or is within the inactive time in the corresponding feedback occasions or feedback resources, so that the peer terminal does not select a resource that causes the problem 1 to transmit the target object.

For example, when the scheduling terminal selects a resource for sending for the peer terminal, the scheduling terminal does not select the resource that is not within the active time (for example, for sending by the terminal 1) or is within the inactive time in the corresponding feedback occasions or feedback resources, so that the scheduling terminal does not select a resource that causes the problem 1 for the peer terminal to transmit the target object.

In another embodiment, for the problem 4, the transmission control method in this embodiment of this application includes at least one of the following:

(1) A resource that is not in an active time (for example, for sending by the terminal 1) or is in an inactive time does not belong to candidate resources, or is excluded from a selection window.

For example, when the terminal 1 determine a resource for sending, the resource that is not within the active time (for example, for sending by the terminal 1) or is within the inactive time does not belong to candidate resources of the terminal 1, or is excluded from the selection window, so that the terminal 1 does not select a resource that causes the problem to transmit the target object.

For example, when the scheduling terminal schedules a resource for sending for the terminal 1, the resource that is not within the active time (for example, for sending by the terminal 1) or is within the inactive time does not belong to candidate resources that can schedule the terminal 1 to perform sending, or is excluded from the selection window, so that the scheduling terminal does not. select a resource that causes the problem 1 for the terminal 1 to transmit the target object.

(2) A resource that is not within an active time (for example, for sending by the terminal 1) or is within an inactive time is not selected.

For example, when the terminal 1 selects a resource for sending from candidate resources, the terminal 1 does not select the resource that is not within the active time (for example, for sending by the terminal 1) or is within the inactive time, so that the peer terminal does not select a resource that causes the problem 1 to transmit the target object.

For example, when the scheduling terminal selects a resource for sending for the peer terminal, the scheduling terminal does not select the resource that is not within the active time (for example, for sending by the terminal 1) or is within the inactive time, so that the scheduling terminal does not select a resource that causes the problem 1 for the terminal 1 to transmit the target object.

In the foregoing embodiments of this application, the peer terminal of the terminal 1 and the terminal 1 may be terminals that perform receiving or sending in a same TB and/or MAC PDU and/or data and/or packet and/or group.

In some embodiments, the first operation includes at least one of the following:

determining a state of the first configuration, where the determined state includes: at least a part of the associated resource of the target object is within the active time or beyond the inactive time of the first configuration;

determining a state of a terminal, where the determined state includes: the terminal is in an active state on at least a part of the associated resource of the target object;

determining that a preset quantity of or all associated resources of the target objects are within the active time or beyond the inactive time;

not expecting the associated resource of the target object to be beyond the active time or within the inactive time of the first configuration_{;} where for example, the terminal 1 does not expect the received or sent associated resource of the target object to be beyond the active time or within the inactive time; and

expecting the associated resource of the target object to be within the active time or beyond the inactive time.

In some embodiments, the target object is a request message, the associated resource of the target object is a response message, and the expecting the associated resource of the target object to be within the active time or beyond the inactive time includes any one of the following:

after a request message is sent to a second terminal, expecting to receive a response message of the second terminal within an active time or beyond an inactive time after the request message; and

receiving the request message of the second terminal, and expecting to send the response message to the second terminal within the active time or beyond the inactive time after the request message.

In some embodiments, the determining a state of the first configuration includes:

prolonging the active time corresponding to the associated resource of the target object, where the preset quantity of or all the associated resources of the target objects are within the prolonged active time.

In some embodiments, the determining a state of a terminal includes:

prolonging the active time corresponding to the associated resource of the target object, where the terminal is in an active state on at least a part of a second associated resource of the target object, and the second associated resource is within the prolonged active time.

In some embodiments, the first operation further includes at least one of the following:

cancelling transmission of a resource within the inactive time or beyond the active time; and

ignoring a resource of a second terminal within the inactive time or beyond the active time, and performing transmission between the second terminal and the first terminal. For example, for multicast, if the peer terminal successfully receives the first transmission, and the transmission reserves a resource reserved for a resource beyond the active time or within the inactive time, the peer terminal may assume that only a same TB is transmitted on these subsequent resources, and therefore the peer terminal no longer receives the TB, for example, automatically enters the inactive time.

It should be noted that the transmission control method provided in the embodiments of this application may be performed by a transmission control apparatus, or a control module that is in the transmission control apparatus and that is configured to perform the transmission control method. In the embodiments of this application, that the transmission control apparatus performs and loads the transmission control method is used as an example to describe the transmission control method provided in the embodiments of this application.

An embodiment of this application provides a transmission control apparatus, applied to a terminal 300. As shown in FIG, 21, the apparatus includes:

a processing module 310, configured to perform any one of the following operations after a target object is transmitted:

transmitting an associated resource of the target object;

scheduling or configuring the associated resource of the target object to be within an active time or beyond an inactive time of a first configuration; and

performing a first operation so that the associated resource of the target object is within the active time or beyond the inactive time of the first configuration.

In this embodiment of this application, after transmitting a target object, a terminal transmits an associated resource of the target object, and/or schedules or configures the associated resource of the target object to be within an active time or beyond an inactive time of a first configuration, and/or performs a first operation so that the associated resource of the target object is within the active time or beyond the inactive time of the first configuration. In this way, the associated resource of the target object can continue to be transmitted, thereby ensuring consistent understanding between a transmit end and a receive end and improving transmission reliability.

In some embodiments, the first operation includes at least one of the following:

determining a state of the first configuration, where the determined state includes: at least a part of the associated resource of the target object is within the active time or beyond the inactive time of the first configuration;

determining a state of a user, where the determined state includes: the user is in an active state on at least a part of the associated resource of the target object;

determining that a preset quantity of or all associated resources of the target objects are within the active time or beyond the inactive time;

not expecting the associated resource of the target object to be beyond the active time or within the inactive time of the first configuration; and

expecting the associated resource of the target object to be within the active time or beyond the inactive time.

In some embodiments, the processing module 310 is configured to perform at least one of the following:

receiving configuration information of a network side device, where the configuration information indicates that the associated resource of the target object is within the active time or beyond the inactive time;

receiving first indication information of a second terminal, where the first indication information indicates that the associated resource of the target object is within the active time or beyond the inactive time, and transmission is performed between the second terminal and the first terminal;

receiving second indication information of a third terminal, where the second indication information indicates that the associated resource of the target object is within the active time or beyond the inactive time, and the third terminal schedules or instructs transmission of the first terminal;

scheduling the associated resource of the target object to be within the active time or beyond the inactive time; and

sending third indication information to the second terminal, where the third indication information indicates that the associated resource of the target object is within the active time or beyond the inactive time.

In some embodiments, the processing module 310 is configured to perform any one of the following:

starting a first timer at a first moment, and transmitting the associated resource of the target object,

transmitting a preset quantity of or all associated resources of the target objects; and

transmitting the preset quantity of or all first associated resources of the target objects, where the first associated resource is beyond the active time or within the inactive time.

In some embodiments, a running time of the first timer is within the active time or beyond the inactive time.

In some embodiments, the first moment includes a time point corresponding to a first object, and the first object includes at least one of the following:

the target object;

the associated resource of the target object;

an active time for the target object; and

the earliest resource in a resource pool in which the target object is located after the active time for the target object.

In some embodiments, if the first object includes a plurality of target objects, the first moment is a time point corresponding to the latest target object in the plurality of target objects; or

if the first object includes the associated resource of the target object, a plurality of first associated resources of the target object are beyond the active time or within the inactive time, and the first moment is a time point corresponding to the earliest associated resource in the plurality of first associated resources.

In some embodiments, the associated resource of the target object is a feedback occasion or a feedback resource corresponding to the target object.

In some embodiments, the first moment is a time point corresponding to the earliest associated resource in the associated resources of the target object.

In some embodiments, the time point corresponding to the first object is any one of the following:

a start point of a time domain resource of the first object;

an end point of the time domain resource of the first object;

a time point of the first n1 time units of the time domain resource of the first object; and

a time point of the last n2 time units of the time domain resource of the first object, where

n1 and n2 are natural numbers.

In some embodiments, the processing module 310 is further configured to perform any one of the following:

if a periodical timer is within the inactive time after expiry or stopping, not enabling the periodical timer or not triggering an associated procedure of the associated resource of the target object;

if a time of the periodical timer overlaps the inactive time after the periodical timer is enabled within the active time, not enabling the periodical timer or not triggering the associated procedure of the associated resource of the target object;

suspending the periodical timer if the periodical timer enters the inactive time during running, and continuing running the periodical timer after entering the active time again; and

clearing or stopping the periodical timer if the periodical timer enters the inactive time during running, and enabling the periodical timer after entering the active time again.

In some embodiments, the target object is a reference signal, and the associated resource of the target object is a measurement report.

In some embodiments, after the clearing or stopping the periodical timer, the processing module 310 is further configured to perform any one of the following:

remaining a report count unchanged; and

generating a measurement report based on some reference signals received within the active time and/or increasing the report count, for example, increasing the report count by one.

In some embodiments, the processing module 310 is configured to prolong the active time corresponding to the associated resource of the target object, where the preset quantity of or all the associated resources of the target objects are within the prolonged active time.

In some embodiments, the processing module 310 is configured to prolong the active time corresponding to the associated resource of the target object, where the user is in an active state on at least a part of a second associated resource of the target object, and the second associated resource is within the prolonged active time.

In some embodiments, the processing module 310 is configured to perform at :least one of the following:

obtaining a terminal type of the first terminal, and transmitting the associated resource of the target object within the active time or beyond the inactive time of the first configuration corresponding to the terminal type of the first terminal;

obtaining latency information of the first terminal, and transmitting the associated resource of the target object within the active time or beyond the inactive time of the first configuration according to the latency information;

obtaining a terminal type of a second terminal, transmitting the associated resource of the target object within the active time or beyond the inactive time of the first configuration corresponding to the terminal type of the second terminal, and performing transmission between the second terminal and the first terminal;

obtaining latency information of the second terminal, and transmitting the associated resource of the target object within the active time or beyond the inactive time of the first configuration according to the latency information;

excluding a first resource from a resource selection window or a candidate resource, where the first resource is beyond the active time or within the inactive time and an associated resource of the first resource is beyond the active time or within the inactive time, or the first resource is within the active time or beyond the inactive time and an associated resource of the first resource is beyond the active time or within the inactive time, or the first resource is beyond the active time or within the inactive time and an associated resource of the first resource is within the active time or beyond the inactive time; and

not selecting a second resource for transmitting the associated resource of the target object, where the second resource is beyond the active time or within the inactive time and an associated resource of the second resource is beyond the active time or within the inactive time, or the second resource is within the active time or beyond the inactive time and an associated resource of the second resource is beyond the active time or within the inactive time, or the second resource is beyond the active time or within the inactive time and an associated resource of the second resource is within the active time or beyond the inactive time.

In some embodiments, the processing module 310 is configured to transmit the associated resource of the target object by a remaining resource after the first resource is excluded from the resource selection window or the candidate resource.

In some embodiments, the latency information includes latency duration and/or an offset of the latency duration.

In some embodiments, the latency duration meets any one of the following:

being less than or equal to a length of the active time;

being less than or equal to a length of a remaining active time after an associated time point of the target object;

at least a part of a time period between an associated time point of sending the target object and an end point corresponding to the latency duration is within the active time or beyond the inactive time; and

at least a part of a time period between the associated time point of sending the target object and expiry of a preset timer is within the active time or beyond the inactive time.

In some embodiments, the target object is a request message, the associated resource of the target object is a response message, and the latency duration meets any one of the following:

being less than or equal to a length of the active time;

being less than or equal to a length of a remaining active time after an associated time point of the request message;

at least a part of a time period between an associated time point of sending the request message and an end point corresponding to the latency duration is within the active time or beyond the inactive time; and

at least a part of a time period between the time point of sending the request message and expiry of a preset timer is within the active time or beyond the inactive time.

In some embodiments, the first indication information and/or the second indication information and/or the third indication information indicate/indicates one or more resources in a time domain resource set within the active time or beyond the inactive time.

In some embodiments, the time domain resource set is obtained after a third resource is excluded, the third resource is within the inactive time or beyond the active time, or an associated. resource of the third resource is within the inactive time or beyond the active time.

In some embodiments, the target object is a request message, the associated resource of the target object is a response message, and the processing module 310 is configured to perform any one of the following:

after a request message is sent to a second terminal, expecting to receive a response message of the second terminal within an active time or beyond an inactive time after the request message; and

receiving the request message of the second terminal, and expecting to send the response message to the second terminal within the active time or beyond the inactive time after the request message.

In some embodiments, the first operation includes at least one of the following:

cancelling transmission of a resource within the inactive time or beyond the active time; and

ignoring a resource of a second terminal within the inactive time or beyond the active time, and performing transmission between the second terminal and the first terminal.

In some embodiments, the target object and/or the associated resource of the target object include/includes at least one of the following:

control information;

a physical shared channel;

a physical control channel;

a Reference Signal (RS);

a sequence;

a physical feedback channel;

a synchronization signal block;

Channel State Information (CSI);

a CSI report;

a connection establishment request;

a connection establishment response;

a connection establishment failure message;

a connection re-establishment request;

a connection re-establishment response;

a Positioning Reference Signal (PRS);

a Phase Tracking Reference Signal (PTRS);

a discovery channel;

a discovery signal;

an RS request;

a sequence request;

an RS indication;

a sequence indication;

an RS response;

a sequence response;

a reference signal measurement report;

a positioning measurement report;

a resource request message;

a resource allocation message; and

a resource recommendation message.

In some embodiments, the target object is control information, and the associated resource of the target object is at least one data resource and/or control resource indicated or reserved by the control information; and/or

the target object is a MAC PM or a TB or a packet or data or control signaling based on a HARQ feedback, and the associated resource of the target object is at least one feedback resource or feedback occasion corresponding to the target object; and/or

the target object is a request message, and the associated resource of the target object is a response to the request message; and/or

the target object is a reference signal or a sequence, and the associated resource of the target object is a measurement report; and/or

the target object is indication information, and the associated resource of the target object is at least one signal, channel, or message indicated by the indication information.

In some embodiments, the target object is a request of an RS or a request of a channel or a request of a message, and the associated resource of the target object is a response to the request message; and/or

the target object is a measurement request, and the associated resource of the target object is a measurement report; and/or

the target object is a connection establishment request, and the associated resource of the target object is a connection establishment response; and/or

the target object is a connection re-establishment request, and the associated resource of the target object is a connection re-establishment response. The connection re-establishment request may be an explicit request, or may be an implicit request. The explicit request may be a direct request for re-establishment by using a request message. The implicit request may be: in a case that cumulative transmission failures or cumulative NACKs or cumulative DTXs or cumulative retransmission times reach a specified value, it is considered that the implicit request is made, and there may or may not be a substantive request message. The implicit request may be alternatively a Radio Link Failure (RLF, or link failure) message.

The transmission control apparatus in this embodiment of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a laptop computer, a palmtop computer, an in-vehicle electronic terminal, a wearable device, an Ultra-Mobile Personal Computer (UMPC), a netbook, or a Personal Digital Assistant (PDA). The non-mobile electronic device may be a Network Attached Storage (NAS), a personal computer, a television, an automated teller machine, or a self-service machine. This is not limited in this embodiment of this application.

The transmission control apparatus in this embodiment of this application may be an apparatus with an operating system. The operating system may be an Android operating system, an iOS operating system, or another possible operating system. This is not limited in the embodiments of this application.

In some implementations, an embodiment of this application further provides an electronic device, including a processor, a memory, and a program or an instruction that is stored in the memory and that can be run on the processor. When the program or the instruction is executed by the processor, the processes of the foregoing transmission control method embodiment are implemented. To avoid repetition, details are not described herein again.

It should be noted that the electronic device in this embodiment of this application includes the foregoing mobile electronic device and the foregoing non-mobile electronic device.

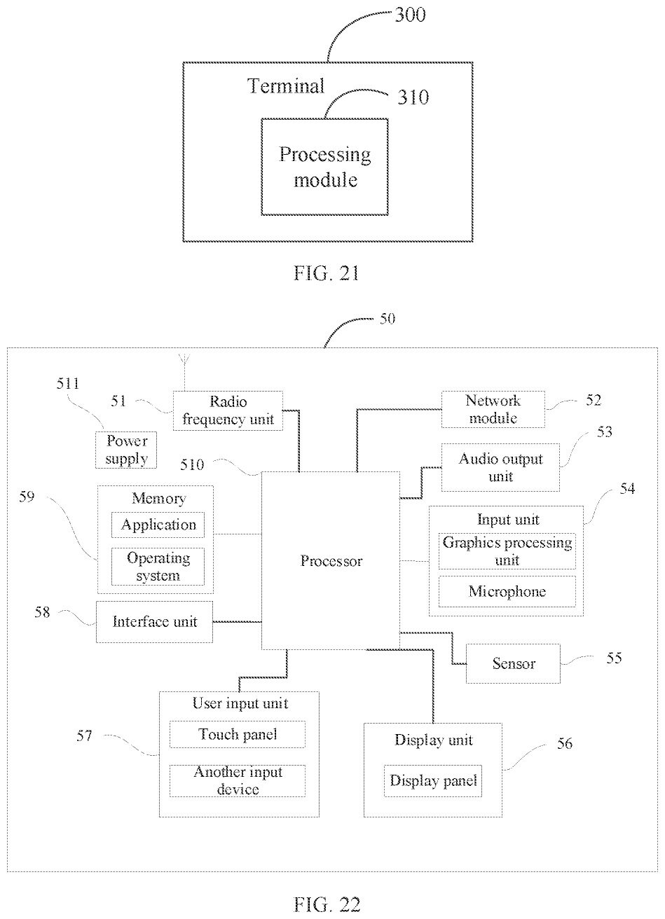

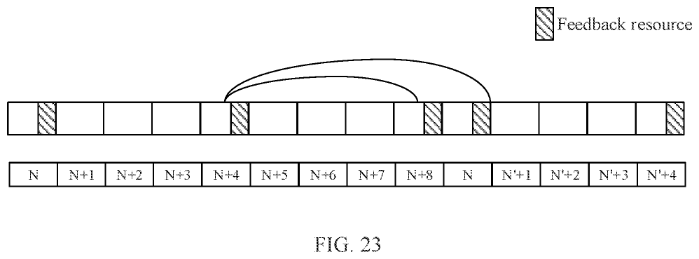

The electronic device in this embodiment may be a terminal. FIG. 22 is a schematic diagram of a hardware structure of a terminal according to the embodiments of this application. A terminal 50 includes but is not limited to components such as a radio frequency unit 51, a network module 52, an audio output unit 53, an input unit 54, a sensor 55, a display unit 56, a user input unit 57, an interface unit 58, a memory 59, a processor 510, and a power supply 511. It can be understood by a person skilled in the art that, the terminal structure shown in FIG. 22 does not constitute any limitation on the terminal, and the terminal may include more or fewer components than those shown in the figure, or combine some components, or have different component arrangements. In this embodiment of this application, the terminal includes but is not limited to a mobile phone, a tablet computer, a notebook computer, a palmtop computer, an in-vehicle terminal, a wearable device, a pedometer, and the like.

It should be understood that, in this embodiment of this application, the radio frequency unit 51 may be configured to receive and send information or a signal in a call process. In some implementations, after receiving downlink data from a base station, the radio frequency unit 51 sends the downlink data to the processor 510 for processing. In addition, the radio frequency unit 51 sends uplink data to the base station. Usually, the radio frequency unit 51 includes but is not limited to an antenna, at least one amplifier, a transceiver, a coupler, a low noise amplifier, a duplexer, and the like, in addition, the radio frequency unit 51 may communicate with a network and another device through a wireless communication system.

The memory 59 may be configured to store a software program and various data. The memory 59 may mainly include a program storage area and a data storage area. The program storage area may store an operating system, an application required by at least one function (such as a sound play function or an image play function), and the like. The data storage area may store data (such as audio data or an address book) created based on use of the mobile phone, and the like. In addition, the memory 59 may include a high-speed random access memory, and may further include a nonvolatile memory, for example, at least one magnetic disk storage device, a flash storage device, or another volatile solid-state storage device.

The processor 510 is a control center of the terminal, and connects all parts of the entire terminal by using various interfaces and lines. By running or executing a software program and/or a module stored in the memory 59 and invoking data stored in the memory 59, the processor 510 performs various functions of the terminal and data processing, to perform overall monitoring on the terminal. The processor 510 may include one or more processing units. Preferably, an application processor and a modem processor may be integrated into the processor 510. The application processor mainly processes an operating system, a user interface, an application, and the like. The modem processor mainly processes wireless communications. It can be understood. that, alternatively, the modem processor may not be integrated into the processor 510.

The terminal 50 may further include the power supply 511 (such as a battery) that supplies power to each component. Preferably, the power supply 511 may be logically connected to the processor 510 by using a power management system, so as to implement functions such as charging, discharging, and power consumption management by using the power management system.

In addition, the terminal 50 includes some function modules not shown, and details are not described herein.

The processor 510 is configured to perform any one of the following operations after a target object is transmitted:

transmitting an associated resource of the target object;

scheduling or configuring the associated resource of the target object to be within an active time or beyond an inactive time of a first configuration; and

performing a first operation so that the associated resource of the target object is within the active time or beyond the inactive time of the first configuration.

In some embodiments, the first operation includes at least one of the following:

determining a state of the first configuration, where the determined state includes: at least some of the associated resource of the target object is within the active time or beyond the inactive time of the first configuration;

determining a state of a user, where the determined state includes: the user is in an active state on at least a part of the associated resource of the target object;

determining that a preset quantity of or all associated resources of the target objects are within the active time or beyond the inactive time;

not expecting the associated resource of the target object to be beyond the active time or within the inactive time of the first configuration; and

expecting the associated resource of the target object to be within the active time or beyond the inactive time.

In some embodiments, the processor 510 is configured to perform at least one of the following:

receiving configuration information of a network side device, where the configuration information indicates that the associated resource of the target object is within the active time or beyond the inactive time;

receiving first indication information of a second terminal, where the first indication information indicates that the associated resource of the target object is within the active time or beyond the inactive time, and transmission is performed between the second terminal and the first terminal;

receiving second indication information of a third terminal, where the second indication information indicates that the associated resource of the target object is within the active time or beyond the inactive time, and the third terminal schedules or instructs transmission of the first terminal;

scheduling the associated resource of the target object to be within the active time or beyond the inactive time; and

sending third indication information to the second terminal, where the third indication information indicates that the associated resource of the target object is within the active time or beyond the inactive time.

In some embodiments, the processor 510 is configured to perform any one of the following:

starting a first timer at a first moment, and transmitting the associated resource of the target object;

transmitting a preset quantity of or all associated resources of the target objects; and transmitting the preset quantity of or all first associated resources of the target objects, where the first associated resource is beyond the active time or within the inactive time.

In some embodiments, a running time of the first timer is within the active time or beyond the inactive time.

In some embodiments, the first moment includes a time point corresponding to a first object, and the first object includes at least one of the following:

the target object;

the associated resource of the target object;

an active time for the target object; and

the earliest resource in a resource pool in which the target object is located after the active time for the target object.

In some embodiments, if the first object includes a plurality of target objects, the first moment is a time point corresponding to the latest target object in the plurality of target objects; or

if the first object includes the associated resource of the target object, a plurality of first associated resources of the target object are beyond the active time or within the inactive time, and the first moment is a time point corresponding to the earliest associated resource in the plurality of first associated resources.

In some embodiments, the associated resource of the target object is a feedback occasion or a feedback resource corresponding to the target object.

In some embodiments, the first moment is a time point corresponding to the earliest associated resource in the associated resources of the target object.

In some embodiments, the time point corresponding to the first object is any one of the following:

a start point of a time domain resource of the first object;

an end point of the time domain resource of the first object;

a time point of the first n1 time units of the time domain resource of the first object; and

a time point of the last n2 time units of the time domain resource of the first object, where

n1 and n2 are natural numbers.

In some embodiments, the processor 510 is further configured to perform any one of the following:

if a periodical timer is within the inactive time after expiry or stopping, not enabling the periodical timer or not triggering an associated procedure of the associated resource of the target object;

if a time of the periodical timer overlaps the inactive time after the periodical timer is enabled within the active time, not enabling the periodical timer or not triggering the associated procedure of the associated resource of the target object;

suspending the periodical timer if the periodical timer enters the inactive time during running, and continuing running the periodical timer after entering the active time again; and

clearing or stopping the periodical timer if the periodical timer enters the inactive time during running, and enabling the periodical timer after entering the active time again.

In some embodiments, the target object is a reference signal, and the associated resource of the target object is a measurement report.

In some embodiments, after the clearing or stopping the periodical timer, the processor 510 is further configured to perform any one of the following:

remaining a report count unchanged; and

generating a measurement report based on some reference signals received within the active time and/or increasing the report count, for example, increasing the report count by one.

In some embodiments, the processor 510 is configured to prolong the active time corresponding to the associated resource of the target object, where the preset quantity of or all the associated resources of the target objects are within the prolonged active time.

In some embodiments, the processor 510 is configured to prolong the active time corresponding to the associated resource of the target object, where the user is in an active state on at least a part of a second associated resource of the target object, and the second associated resource is within the prolonged active time:

In some embodiments, the processor 510 is configured to perform at least one of the following:

obtaining a terminal type of the first terminal, and transmitting the associated resource of the target object within the active time or beyond the inactive time of the first configuration corresponding to the terminal type of the first terminal;

obtaining latency information of the first terminal, and transmitting the associated resource of the target object within the active time or beyond the inactive time of the first configuration according to the latency information;

obtaining a terminal type of a second terminal, transmitting the associated resource of the target object within the active time or beyond the inactive time of the first configuration corresponding to the terminal type of the second terminal, and performing transmission between the second terminal and the first terminal;

obtaining latency information of the second terminal, and transmitting the associated resource of the target object within the active time or beyond the inactive time of the first configuration according to the latency information;

excluding a first resource from a resource selection window or a candidate resource, where the first resource is beyond the active time or within the inactive time and an associated. resource of the first resource is beyond the active time or within the inactive time, or the first resource is within the active time or beyond the inactive time and an associated resource of the first resource is beyond the active time or within the inactive time, or the first resource is beyond the active time or within the inactive time and an associated resource of the first resource is within the active time or beyond the inactive time; and

not selecting a second resource for transmitting the associated resource of the target object, where the second resource is beyond the active time or within the inactive time and an associated resource of the second resource is beyond the active time or within the inactive time, or the second resource is within the active time or beyond the inactive time and an associated resource of the second resource is beyond the active time or within the inactive time, or the second resource is beyond the active time or within the inactive time and an associated resource of the second resource is within the active time or beyond the inactive time.

In some embodiments, the processor 510 is configured to transmit the associated resource of the target object by a remaining resource after the first resource is excluded from the resource selection window or the candidate resource.

In some embodiments, the latency information includes latency duration and/or an offset of the latency duration.

In some embodiments, the latency duration meets any one of the following:

being less than or equal to a length of the active time;

being less than or equal to a length of a remaining active time after an associated time point of the target object;

at least a part of a time period between an associated time point of sending the target object and an end point corresponding to the latency duration is within the active time or beyond the inactive time; and

at least a part of a time period between the associated time point of sending the target object and expiry of a preset timer is within the active time or beyond the inactive time.

In some embodiments, the target object is a request message, the associated resource of the target object is a response message, and the latency duration meets any one of the following:

being less than or equal to a length of the active time;

being less than or equal to a length of a remaining active time after an associated time point of the request message;

at least a part of a time period between an associated time point of sending the request message and an end point corresponding to the latency duration is within the active time or beyond the inactive time; and

at least a part of a time period between the time point of sending the request message and expiry of a preset timer is within the active time or beyond the inactive time.

In some embodiments, the first indication information and/or the second indication information and/or the third indication information indicate/indicates one or more resources in a time domain resource set within the active time or beyond the inactive time.

In some embodiments, the time domain resource set is obtained after a third resource is excluded, the third resource is within the inactive time or beyond the active time, or an associated resource of the third resource is within the inactive time or beyond the active time.

In some embodiments, the target object is a request message, the associated resource of the target object is a response message, and the processor 510 is configured to perform any one of the following:

after a request message is sent to a second terminal, expecting to receive a response message of the second terminal within an active time or beyond an inactive time after the request message; and

receiving the request message of the second terminal, and expecting to send the response message to the second terminal within the active time or beyond the inactive time after the request message.

In some embodiments, the first operation includes at I east one of the following:

cancelling transmission of a resource within the inactive time or beyond the active time; and

ignoring a resource of a second terminal within the inactive time or beyond the active time, and performing transmission between the second terminal and the first terminal.

In some embodiments, the target object and/or the associated resource of the target object include/includes at least one of the following:

control information;

a physical shared channel;

a physical control channel;

an RS;

a sequence;

a physical feedback channel;

a synchronization signal block;

CSI;

a CSI report;

a connection establishment request;

a connection establishment response:

a connection establishment failure message;

a connection re-establishment request;

a connection re-establishment response;

a PRS;

a PTRS;

a discovery channel;

a discovery signal;

an RS request;

a sequence request;

an RS indication;

a sequence indication;

an RS response;

a sequence response;

a reference signal measurement report;

a positioning measurement report;

a resource request message;

a resource allocation message; and

a resource recommendation message.

In some embodiments, the target object is control information, and the associated resource of the target object is at least one data resource and/or control resource indicated or reserved by the control information; and/or

the target object is a MAC PDU or a TB or a packet or data or control signaling based on a HARQ feedback, and the associated resource of the target object is at least one feedback resource or feedback occasion corresponding to the target object; and/or

the target object is a request message, and the associated resource of the target object is a response to the request message; and/or

the target object is a reference signal or a sequence, and the associated resource of the target object is a measurement report; and/or

the target object is indication information, and the associated resource of the target object is at least one signal or channel or message indicated by the indication information.

In some embodiments, the target object is a request of an RS or a request of a channel or a request of a message, and the associated resource of the target object is a response to the request message; and/or

the target object is a measurement request, and the associated resource of the target object is a measurement report; and/or

the target object is a connection establishment request, and the associated resource of the target object is a connection establishment response; and/or

the target object is a connection re-establishment request, and the associated resource of the target object is a connection re-establishment response. The connection re-establishment request may be an explicit request, or may be an implicit request. The explicit request may be a direct request for re-establishment by using a request message. The implicit request may be: in a case that cumulative transmission failures or cumulative NACKs or cumulative DTXs or cumulative retransmission times reach a specified value, it is considered that the implicit request is made, and there may or may not be a substantive request message. The implicit request may be alternatively an RLF message.

An embodiment of this application further provides a readable storage medium. The readable storage medium stores a program or an instruction, and when the program or the instruction is executed by a processor, the processes of the foregoing transmission control method embodiment are implemented and a same technical effect can be achieved. To avoid repetition, details are not described herein again.

The processor is a processor in the electronic device in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communications interface, the communications interface is coupled to the processor, and the processor is configured to run a program or an instruction to implement the processes of the foregoing transmission control method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

In some cases, there are at least two feedback resources that meet a first mapping relationship with a target SL resource. If a terminal reports information about only one of the feedback resources to a network side, the network side cannot determine information about another feedback resource. Therefore, an embodiment of this application provides an information processing method, including:

for a target SL resource that meets a first condition in an SL resource, determining, by a terminal, reporting information of the target SL resource, where

the first condition is: there are at least two feedback resources that meet a first mapping relationship with the target SL resource, and the first mapping relationship is that an interval between the feedback resource and the SL resource is within a preset range.

The preset range is configured by a network side device or stipulated in a protocol. According to this embodiment of this application, if there are at least two feedback resources that meet the first mapping relationship with the target SL resource, the network side can also learn information about the feedback resources.

In some embodiments, the determining reporting information of the target SL resource includes:

for a first preset feedback resource that meets the first mapping relationship with the target SL resource, determining that reporting information corresponding to the target SL resource or the first preset feedback resource is a first value.

In some embodiments, the determining that reporting information corresponding to the target SL resource or the first preset feedback resource is a first value includes any one of the following:

the first value is Hybrid. Automatic Repeat reQuest ACKnowledgement (HARQ-ACK) information corresponding to a second preset feedback resource that meets the first mapping relationship with the target SL resource;

the first value is HARQ-ACK information corresponding to the target SL resource; and

the first value is HARQ-ACK information or a decoding state corresponding to a target transport block, where

the target transport block is a transport block transmitted on the target SL resource.

If a PSSCH having A (A is an integer greater than or equal to 2) feedback resources corresponds to reporting information of a second feedback resource, reporting information (that is, a first value) of the second, third, . . . , or A^{th} feedback resource corresponding to the PSSCH needs to be separately determined. The first value may be set to be the same as content of the reporting information corresponding to a first feedback resource, or may be set to HARQ-ACK information corresponding to the PSSCH, or may be set to HARQ-ACK information or a decoding state corresponding to a TB carried in the PSSCH.

In some embodiments, the second preset feedback resource is the earliest feedback resource in feedback resources that meet the first mapping relationship with the target SL resource. The earliest means the earliest in time domain.

In some embodiments, the first preset feedback resource is later than a second preset feedback resource.

In this embodiment of this application, after obtaining SL HARQ information, the terminal device may send the information to the network side device by using a Physical Uplink Control CHannel (PUCCH) or a Physical Uplink Shared CHannel (PUSCH). The reporting information may be understood as the SL HARQ information sent to the network device by using the Physical Uplink Control CHannel (PUCCH) or the Physical Uplink Shared CHannel (PUSCH).

The first mapping relationship may be understood as a mapping relationship between a PSCCH and/or a PSSCH and a PSFCH, and may be determined according to values of N and K, where N represents a period of a feedback resource, and K represents a minimum interval between an SL resource and a corresponding feedback resource. A feedback resource that meets the first mapping relationship with the target SL resource may be understood as that an interval between the target SL resource and the feedback resource is within a preset range. For example, the preset range may be interpreted as: the interval between the target SL resource and the feedback resource is not less than N, or the interval between the target SL resource and the feedback resource is not greater than N+K+Y. In some implementations, Y is an integer. example, Y may be 0, −1, 1, 2, or 3. In some implementations, V is not greater than N−1.

In some implementations, that the target SL resource includes at least two corresponding feedback resources according to the first mapping relationship may be understood as that the target SL resource includes the at least two corresponding feedback resources according to the first mapping relationship in a current first time period. In another embodiment, it may be further understood that the target SL resource can find the at least two corresponding feedback resources according to the first mapping relationship in a current first time period and a next first time period. The first time period may be one or more resource pool periods, may be a time corresponding to a length of one or more resource configuration bitmaps, or may be one or more 10240 ms.

As shown in FIG. 23, in the case of K=2 and N=4, two feedback resources that meet the first mapping relationship may be found in a slot n+4, and are respectively located in a slot n+7 and a slot n+6.

That the first value is HARQ-ACK information corresponding to a second preset feedback resource that meets the first mapping relationship with the target SL resource may be understood as that the first value is HARQ-ACK information carried or indicated or corresponding to the second preset feedback resource that meets the first mapping relationship with the target SL resource, In some implementations, the first value may be considered as duplication of the HARQ-ACK information carried or indicated or corresponding to the second preset feedback resource that meets the first mapping relationship with the target SL resource, For example, if the second preset feedback resource carries or indicates a NACK, the first value is the NACK, and if the second preset feedback resource indicates an ACK, the second preset feedback resource indicates the ACK. The HARQ-ACK information corresponding to the second preset feedback resource that meets the first mapping relationship with the target SL resource means that if the second preset feedback resource is not detected, it is considered that the first value is an ACK. or a NACK. In some implementations, when SCI indicates a unicast or multicast feedback mechanism 2 or instructs to use an ACK or NAM-based feedback, if the second preset feedback resource is not detected, it is considered that the first value is a NACK. For example, when SCI indicates a multicast feedback mechanism 1 or instructs to use a NACK-based feedback, if the second preset feedback resource is not detected, it is considered that the first value is an ACK.

That the first value is HARQ-ACK information corresponding to the target SL resource may be understood as that the first value is the HARQ-ACK information corresponding to the target SL resource. In an implementation, the first value is HARQ-ACK information corresponding to the second preset feedback resource that meets the first mapping relationship with the target SL resource.

The first value is the HARQ-ACK information or the decoding state corresponding to the target transport block, where the target transport block is a transport block transmitted on the target SL resource. It can be understood that a sending user considers whether a TB is successfully decoded by a receiving end. For example, the HARQ-ACK information corresponding to the target transport block is a NACK or an ACK. For example, after the sending user considers that a TB is successfully decoded by all receiving ends, it may be considered that a decoding state of the TB is a NACK; otherwise, the decoding state is a NACK.

The second preset feedback resource is the earliest feedback resource in the feedback resources that meet the first mapping relationship with the target SL resource. For example, if a PSSCH in a slot n+4 meets the first mapping relationship with a PSFCH in a slot n+7 and a PSFCH in a slot n+6, the second preset feedback resource is the PSFCH in the slot n+6.

The first preset feedback resource is later than the second preset feedback resource. For example, if a PSSCH in a slot n+4 meets the first mapping relationship with a PSFCH in a slot n+7 and a PSFCH in a slot n+6, the first preset feedback resource is the PSFCH in the slot n+7.

In another implementation, there is no reporting information corresponding to the first feedback resource, or the target SL resource does not have reporting information corresponding to the first feedback resource. That there is no reporting information corresponding to the first feedback resource may be understood as that reporting information corresponding to the first feedback resource does not exist. That the target SL resource does not have reporting information corresponding to the first feedback resource may be understood as that the target SL resource does not have reporting information corresponding to the first feedback resource. In some implementations, another SL resource that meets the first mapping relationship with the first feedback resource may still have the reporting information of the first feedback resource.

example, an SL resource in a slot n+4 meets the first mapping relationship with a PSFCH in a slot n+7 and a PSFCH in a slot n+6. For a PSFCH slot in the slot n+6, HARQ-ACK information corresponding to the target SL resource in the slot n+4 is reported. For a PSFCH slot in the slot n+7, no HARQ-ACK information needs to be reported for the corresponding target SL resource in the slot n+4. However, in some implementations, the PSFCH slot may also meet the first mapping relationship with another SL resource. In this case, there may be HARQ-ACK information that needs to be reported for the another SL resource, or for a PSFCH slot in the slot n+7, no HARQ-ACK information needs to be reported for any corresponding SL resource.

It should be noted that the information processing method provided in the embodiments of this application may be performed by an information processing apparatus, or a control module that is in the information processing apparatus and that is configured to perform the information processing method. In the embodiments of this application, that the information processing apparatus performs and loads the information processing method is used as an example to describe the information processing method provided in the embodiments of this application,

An embodiment of this application provides an information processing apparatus, including:

a processing module, configured to: for a target SL resource that meets a first condition in an SL resource, determine reporting information of the target SL resource, where

the first condition is: there are at least two feedback resources that meet a first mapping relationship with the target SL resource, and the first mapping relationship is that an interval between the feedback resource and the SL resource is within a preset range.

In some embodiments, the processing module is configured to: for a first preset feedback resource that meets the first mapping relationship with the target SL resource, determine that reporting information corresponding to the target SL resource or the first preset feedback resource is a first value.

In some embodiments, the processing module is configured to perform any one of the following:

the first value is HARQ-ACK information corresponding to a second preset feedback resource that meets the first mapping relationship with the target SL resource;

the first value is HARQ-ACK information corresponding to the target SL resource; and

the first value is HARQ-ACK information or a decoding state corresponding to a target transport block, where

the target transport block is a transport block transmitted on the target SL resource.

In some embodiments, the second preset feedback resource is the earliest feedback resource in feedback resources that meet the first mapping relationship with the target SL resource.

In some embodiments, the first preset feedback resource is later than a second preset feedback resource.

The information processing apparatus in this embodiment of this application may be an apparatus, or may be a component, an integrated circuit, or a chip in a terminal. The apparatus may be a mobile electronic device, or may be a non-mobile electronic device.

For example, the mobile electronic device may be a mobile phone, a tablet computer, a laptop computer, a palmtop computer, an in-vehicle electronic terminal, a wearable device, a UMPC, a netbook, or a PDA. The non-mobile electronic device may be an NAS, a personal computer, a television, an automated teller machine, or a self-service machine. This is not limited in this embodiment of this application.

The information processing apparatus in this embodiment of this application may be an apparatus with an operating system. The operating system may be an Android operating system, an iOS operating system, or another possible operating system. This is not limited in the embodiments of this application.

In some implementations, an embodiment of this application further provides an electronic device, including a processor, a memory, and a program or an instruction that is stored in the memory and that can be run on the processor. When the program or the instruction is executed by the processor, the processes of the foregoing information processing method embodiment are implemented, To avoid repetition, details are not described herein again.

It should be noted that the electronic device in this embodiment of this application includes the foregoing mobile electronic device and the foregoing non-mobile electronic device.

The electronic device in this embodiment may be a terminal, FIG. 22 is a schematic diagram of a hardware structure of a terminal according to the embodiments of this application. A terminal 50 includes but is not limited to components such as a radio frequency unit 51, a network module 52, an audio output unit 53, an input unit 54, a sensor 55, a display unit 56, a user input unit 57, an interface unit 58, a memory 59, a processor 510, and a power supply 511. It can be understood by a person skilled in the art that, the terminal structure shown in FIG. 22 does not constitute any limitation on the terminal, and the terminal may include more or fewer components than those shown in the figure, or combine some components, or have different component arrangements. In this embodiment of this application, the terminal includes but is not limited to a mobile phone, a tablet computer, a notebook computer, a palmtop computer, an in-vehicle terminal, a wearable device, a pedometer, and the like.

It should be understood that, in this embodiment of this application, the radio frequency unit 51 may be configured to receive and send information or a signal in a call process. Specifically, after receiving downlink data from a base station, the radio frequency unit 51 sends the downlink data to the processor 510 for processing. In addition, the radio frequency unit 51 sends uplink data to the base station. Usually, the radio frequency unit 51 includes but is not limited to an antenna, at least one amplifier, a transceiver, a coupler, a low noise amplifier, a duplexer, and the like. In addition, the radio frequency unit 51 may communicate with a network and another device through a wireless communication system.

The memory 59 may be configured to store a software program and various data. The memory 59 may mainly include a program storage area and a data storage area. The program storage area may store an operating system, an application required by at least one function (such as a sound play function or an image play function), and the like. The data storage area may store data (such as audio data or an address book) created based on use of the mobile phone, and the like. In addition, the memory 59 may include a high-speed random access memory, and may further include a nonvolatile memory, for example, at least one magnetic disk storage device, a flash storage device, or another volatile solid-state storage device.

The processor 510 is a control center of the terminal, and connects all parts of the entire terminal by using various interfaces and lines. By running or executing a software program and/or a module stored in the memory 59 and invoking data stored in the memory 59, the processor 510 performs various functions of the terminal and data processing, to perform overall monitoring on the terminal. The processor 510 may include one or more processing units. Preferably, an application processor and a modem processor may be integrated into the processor 510. The application processor mainly processes an operating system, a user interface, an application, and the like. The modem processor mainly processes wireless communications. it can be understood that, alternatively, the modern processor may not be integrated into the processor 510.

The terminal 50 may further include the power supply 511 (such as a battery) that supplies power to each component. Preferably, the power supply 511 may be logically connected to the processor 510 by using a power management system, so as to implement functions such as charging, discharging, and power consumption management by using the power management system.

In addition, the terminal 50 includes some function modules not shown, and details are not described herein.

An embodiment of this application further provides a readable storage medium. The readable storage medium stores a program or an instruction, and when the program or the instruction is executed by a processor, the processes of the foregoing information processing method embodiment are implemented. To avoid repetition, details are not described herein again.

The processor is a processor in the electronic device in the foregoing embodiment. The readable storage medium includes a computer-readable storage medium, such as a computer ROM, an RAM, a magnetic disk, or an optical disc.

An embodiment of this application further provides a chip. The chip includes a processor and a communications interface, the communications interface is coupled to the processor, and the processor is configured to run a program or an instruction to implement the processes of the foregoing information processing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

A person of ordinary skill in the art may be aware that, in combination with the examples described in the embodiments disclosed in this specification, units and algorithm steps may be implemented by using electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It can be understood by a person skilled in the art that, for the purpose of convenient and brief description, for a detailed operating process of the foregoing system, apparatus, and unit, refer to a corresponding process in the foregoing method embodiments. Details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, or each of the units may exist alone physically, or two or more units are integrated into one unit.

Based on the descriptions of the foregoing implementations, a person skilled in the art may understand that the method in the foregoing embodiment may be implemented by software in addition to a necessary universal hardware platform or by hardware only. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

It can be understood that the embodiments described in the embodiments of the present disclosure may be implemented by hardware, software, firmware, middleware, microcode, or a combination thereof. For hardware implementation, a module, a unit, or a subunit may be implemented in one or more Application Specific Integrated Circuits (ASIC), Digital Signal Processor (DSP), DSP Device (DSPD), Programmable Logic Device (PLD), Field-Programmable Gate Array (FPGA), general purpose processors, controllers, microcontrollers, microprocessors, or other electronic units or a combination thereof used to perform the functions in the present disclosure.

For software implementation, the technology in the embodiments of the present disclosure may be implemented through modules (for example, procedures or functions) that perform the functions in the embodiments of the present disclosure. Software code may be stored in a memory and executed by a processor. The memory may be implemented in the processor or outside the processor.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A transmission control method, comprising:
performing, by a first terminal, any one of the following operations after transmitting a target object:
transmitting an associated resource of the target object;
scheduling or configuring the associated resource of the target object to be within an active time or beyond an inactive time of a first configuration; or
performing a first operation so that the associated resource of the target object is within the active time or beyond the inactive time of the first configuration.

2. The transmission control method according to claim 1, wherein the first operation comprises at least one of the following:
determining a state of the first configuration, wherein the state of the first configuration comprises: at least some of the associated resource of the target object is within the active time or beyond the inactive time of the first configuration;
determining a state of a user, wherein the state of the user comprises: the user is in an active state on at least a part of the associated resource of the target object;
determining that a preset quantity of or all associated resources of the target objects are within the active time or beyond the inactive time;
not expecting, the associated resource of the target object to be beyond the active time or within the inactive time of the first configuration; or
expecting the associated resource of the target object to be within the active time or beyond the inactive time.

3. The transmission control method according to claim 1, wherein the scheduling or configuring the associated resource of the target object to be within an active time or beyond an inactive time of a first configuration comprises at least one of the following:
receiving configuration information of a network side device, wherein the configuration information indicates that the associated resource of the target object is within the active time or beyond the inactive time;
receiving first indication information of a second terminal, wherein the first indication information indicates that the associated resource of the target object is within the active time or beyond the inactive time, and transmission is performed between the second terminal and the first terminal;
receiving second indication information of a third terminal, wherein the second indication information indicates that the associated resource of the target object is within the active time or beyond the inactive time, and the third terminal schedules or instructs transmission of the first terminal;
scheduling the associated resource of the target object to be within the active time or beyond the inactive time; or
sending third indication information to the second terminal, wherein the third indication information indicates that the associated resource of the target object is within the active time or beyond the inactive time.

4. The transmission control method according to claim 1, wherein the transmitting an associated resource of the target object comprises any one of the following:
starting a first timer at a first moment, and transmitting the associated resource of the target object;
transmitting a preset quantity of or all associated resources of target objects; or
transmitting the preset quantity of or all first associated resources of target objects, wherein the first associated resource is beyond the active time or within the inactive time.

5. The transmission control method according to claim 4, wherein a running time of the first timer is within the active time or beyond the inactive time, or
wherein the first moment comprises a time point corresponding to a first object, and the first object comprises at least one of the following:
the target object;
the associated resource of the target object;
an active time for the target object; or
the earliest resource in a resource pool in which the target object is located after the active time for the target object.

6. The transmission control method according to claim 1, further comprising any one of the following:
when a periodical timer is within the inactive time after expiry or stopping, not enabling the periodical timer or not triggering an associated procedure of the associated resource of the target object;
when a time of the periodical timer overlaps the inactive time after the periodical timer is enabled within the active time, not enabling the periodical timer or not triggering the associated procedure of the associated resource of the target object;
suspending the periodical timer when the periodical timer enters the inactive time during running, and continuing running the periodical timer after entering the active time again; or
clearing or stopping the periodical timer when the periodical timer enters the inactive time during running, and enabling the periodical timer after entering the active time again.

7. The transmission control method according to claim 6, wherein after the clearing or stopping the periodical timer, the method further comprises any one of the following:
remaining a report count unchanged; or
generating a measurement report based on some reference signals received within the active time or increasing the report count.

8. The transmission control method according to claim 2, wherein the determining a state of the first configuration comprises:
prolonging the active time corresponding to the associated resource of the target object, wherein the preset quantity of or all the associated resources of the target objects are within the prolonged active time, or wherein the determining a state of a user comprises:
prolonging the active time corresponding to the associated resource of the target object, wherein the user is in an active state on at least some of a second associated resource of the target object, and the second associated resource is within the prolonged active time.

9. The transmission control method according to claim 1, wherein the transmitting an associated resource of the target object comprises at least one of the following:
obtaining a terminal type of the first terminal, and transmitting the associated resource of the target object within the active time or beyond the inactive time of the first configuration corresponding to the terminal type of the first terminal;
obtaining latency information of the first terminal, and transmitting the associated resource of the target object within the active time or beyond the inactive time of the first configuration according to the latency information;
obtaining a terminal type of a second terminal, transmitting the associated resource of the target object within the active time or beyond the inactive time of the first configuration corresponding to the terminal type of the second terminal, wherein transmission is between the second terminal and the first terminal;
obtaining latency information of the second terminal, and transmitting the associated resource of the target object within the active time or beyond the inactive time of the first configuration according to the latency information;
excluding a first resource from a resource selection window or a candidate resource, wherein the first resource is beyond the active time or within the inactive time and an associated resource of the first resource is beyond the active time or within the inactive time, or the first resource is within the active time or beyond the inactive time and an associated resource of the first resource is beyond the active time or within the inactive time, or the first resource is beyond the active time or within the inactive time and an associated resource of the first resource is within the active time or beyond the inactive time; or
not selecting a second resource for transmitting the associated resource of the target object, wherein the second resource is beyond the active time or within the inactive time and an associated resource of the second resource is beyond the active time or within the inactive time, or the second resource is within the active time or beyond the inactive time and an associated resource of the second resource is beyond the active time or within the inactive time, or the second resource is beyond the active time or within the inactive time and an associated resource of the second resource is within the active time or beyond the inactive time.

10. The transmission control method according to claim 3, wherein the first indication information, the second indication information, or the third indication information indicates one or more resources in a time domain resource set within the active time or beyond the inactive time.

11. The transmission control method according to claim 2, wherein the target object is a request message, the associated resource of the target object is a response message, and the expecting the associated resource of the target object to be within the active time or beyond the inactive time comprises any one of the following:
after a request message is sent to a second terminal, expecting to receive a response message of the second terminal within an active time or beyond an inactive time after the request message; or
receiving the request message of the second terminal, and expecting to send the response message to the second terminal within the active time or beyond the inactive time after the request message.

12. The transmission control method according to claim 1, wherein the first operation comprises at least one of the following:
cancelling transmission of a resource within the inactive time or beyond the active time; or
ignoring a resource of a second terminal within the inactive time or beyond the active time, and performing transmission between the second terminal and the first terminal.

13. The transmission control method according to claim 1, wherein the target object or the associated resource of the target object comprises at least one of the following:
control information;
a physical shared channel;
a physical control channel;
a Reference Signal (RS);
a sequence;
a physical feedback channel;
a synchronization signal block;
Channel State Information (CSI);
a CSI report;
a connection establishment request;
a connection establishment response;
a connection establishment failure message;
a connection re-establishment request;
a connection re-establishment response;
a Positioning Reference Signal (PRS);
a Phase Tracking Reference Signal (MRS);
a discovery channel;
a discovery signal;
an RS request;
a sequence request;
an RS indication;
a sequence indication;
an RS response;
a sequence response;
a reference signal measurement report;
a positioning measurement report;
a resource request message;
a resource allocation message; or
a resource recommendation message.

14. The transmission control method according to claim 13, wherein
the target object is control information, and the associated resource of the target object is at least one data resource or control resource indicated or reserved by the control information;
the target object is a Media Access Control Protocol Data Unit (MAC PDU), a Transport Block (TB), a packet data or control signaling based on a Hybrid Automatic Repeat reQuest (HARQ) feedback, and the associated resource of the target object is at least one feedback resource or feedback occasion corresponding to the target object;
the target object is a request message, and the associated resource of the target object is a response to the request message;
the target object is a reference signal or a sequence, and the associated resource of the target object is a measurement report; or
the target object is indication information, and the associated resource of the target object is at least one signal, channel, or message indicated by the indication information.

15. An information processing method, comprising:
for a target SideLink (SL) resource that meets a first condition in a SL resource, determining, by a terminal, reporting information of the target SL resource, wherein
the first condition is: there are at least two feedback resources that meet a first mapping relationship with the target SL resource, and the first mapping relationship is that an interval between the feedback resource and the SL resource is within a preset range.

16. The method according to claim 15, wherein the determining reporting information of the target SL resource comprises:
for a first preset feedback resource that meets the first mapping relationship with the target SL resource, determining that reporting information corresponding to the target SL resource or the first preset feedback resource is a first value.

17. The method according to claim 16, wherein the determining that reporting information corresponding to the target SL resource or the first preset feedback resource is a first value comprises any one of the following:
the first value is Hybrid Automatic Repeat reQuest ACKnowledgement (HARQ-ACK) information corresponding to a second preset feedback resource that meets the first mapping relationship with the target SL resource;
the first value is HARQ-ACK information corresponding to the target SL resource; or
the first value is HARQ-ACK information or a decoding state corresponding to a target transport block, wherein
the target transport block is a transport block transmitted on the target SL resource.

18. The method according to claim 16, wherein the first preset feedback resource is later than a second preset feedback resource.
